(19) United States
(12) Patent Application Publication
(10) Pub. No.: US 2002/0077871 A1
(43) Pub. Date: Jun. 20, 2002

(54) Traveler service system with a graphical user interface for accessing multiple travel suppliers

(76) Inventors: Greg Udelhoven, Pylmouth, MN (US); Greg Adams, Wayzata, MN (US); Scott Ostlund, White Bear Township, MN (US); Craig Schreiner, Eagan, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/886,457

(22) Filed: Jun. 20, 2001

Related U.S. Application Data
(60) Provisional application No. 60/212,920, filed on Jun. 20, 2000.

(51) Int. Cl. G06F 17/60

(52) U.S. Cl. 705/5

(57) ABSTRACT

A travel service system and related methods provide a unified and consistent Graphical User Interface (GUI) to travel counselors regardless of the General Distribution System that maintains travel related services and reservations. The system is capable of interfacing with multiple air, car and hotel reservation systems. In addition, the system maintains traveler profiles that include data indicating a traveler's preferences, biographical data, and preferred payment information. Furthermore, the system maintains data regarding a client's travel policies and contracts with various travel service suppliers such as airlines, hotels, and car rental agencies. The data from these various sources can be used to provide default information for various fields in the interface, and to search for and provide travel services that are consistent with the client's travel policies. In some embodiments of the invention, the system enforces the client's travel policies by not allowing a user to select options that would violate the client's travel policies.

### RELATED FILES

This application claims the benefit of U.S. Provisional Application No. 60/212,920 filed Jun. 20, 2000, which is hereby incorporated by reference for all purposes.

### FIELD

The present invention relates generally to traveler service systems, and more particularly to traveler service systems capable of accessing multiple service suppliers such as travel service supplier systems.

### Copyright Notice/Permission

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2000, 2001 Carlson Companies, Inc. All Rights Reserved.

### BACKGROUND

The travel industry has a long history of applying computer and information technology to the problem of reserving and booking airline seats, hotel rooms, rental cars and other travel related services. For example, global distribution systems (GDSs) and computerized reservation systems (CRSs) such as Sabre, Galileo (also known as Apollo), Amadeus, and Worldspan were developed to maintain inventory of available travel services and to track bookings and reservations against the available inventory. Generally, these systems comprise large mainframe systems. Because these systems were typically developed before the advent of modem graphical user interfaces (GUI), the user interface is typically terminal based, and input to the system comprises short, often cryptic, command strings that cause the system to display requested information.

A typical traveler needs to make multiple reservations on any one trip. For example, the traveler will often need to book a flight, a hotel, and a rental car. Thus, in order to use the above systems to obtain information for the traveler, a user (typically a travel counselor that makes travel arrangements on behalf of the traveler) must be conversant in the commands for multiple GDSs. In addition, the travel counselor must typically issue multiple requests to multiple systems to receive desired information. As a result, using the currently available systems, a travel counselor must manually switch between multiple GDS screens in order to complete the traveler's booking needs.

Furthermore, it is often the case that the booking needs for a trip cannot be completed during a single session. For example, it may be necessary to place the travel request on a queue because a desired flight, hotel room, or car is not currently available on the desired travel date. In these cases, the travel counselor must manually check the queue and reissue requests for the previously unavailable travel service.

An additional issue arises for travelers that are traveling for business purposes. Often a business will have travel policies and preferences that the traveler and the travel counselor must adhere to. For example, a business may have negotiated discount rates with a travel service supplier. The traveler and travel counselor acting on behalf of the business must therefore use the travel supplier whenever possible in order to gain the advantage of the discount. A further example of a travel policy is a requirement that corporate travel be paid for using a particular corporate account or credit card. GDS systems of the prior art have no way of maintaining information regarding such policies.

As a result of the foregoing problems, there is a need in the art for the present invention.

### SUMMARY

The embodiments of the invention described below provide a travel service system that provides a unified and consistent Graphical User Interface (GUI) to travel counselors regardless of the General Distribution System that maintains travel related services and reservations. The system is capable of interfacing with multiple air, car and hotel reservation systems. In addition, the system maintains traveler profiles that include data indicating a traveler's preferences, biographical data, and preferred payment information. Furthermore, the system maintains data regarding a client's travel policies and contracts with various travel service suppliers such as airlines, hotels, and car rental agencies. The data from these various sources can be used to provide default information for various fields in the interface, and to search for and provide travel services that are consistent with the client's travel policies. In some embodiments of the invention, the system enforces the client's travel policies by not allowing a user to select options that would violate the client's travel policies.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of the major components of a traveler service system according to an embodiment of the invention;

FIG. 2 is a block diagram providing further details of a traveler service system according to an embodiment of the invention;

FIG. 3 illustrates an exemplary login screen of an exemplary user interface according to an embodiment of the invention;

FIG. 4 illustrates an exemplary main itinerary window according to an embodiment of the invention;

FIGS. 5A-5L illustrate exemplary windows according to an embodiment of the invention that provide for the creation and maintenance of a traveler profile;

FIGS. 6A-6W illustrate exemplary air travel windows according to an embodiment of the invention;

FIGS. 7A-7C illustrate exemplary windows for a component that maintains car rental information according to an embodiment of the invention;

FIGS. 8A-8D illustrate exemplary windows for a component that maintains hotel availability and booking information according to an embodiment of the invention;

FIG. 9 illustrates an exemplary window for a component that maintains limousine reservation information;

FIG. 10 illustrates a travel order copy component according to an embodiment of the invention;

FIGS. 11A-11D illustrate exemplary additional information windows provided in various embodiments of the invention;

FIGS. 12A and 12B illustrate exemplary travel document windows according to an embodiment of the invention;

FIGS. 13A-13D illustrate exemplary windows of a deferred task component according to an embodiment of the invention;

FIG. 14 illustrates an exemplary customer service window according to an embodiment of the invention;

FIGS. 15A-15D illustrate exemplary monitor windows according to an embodiment of the invention;

FIGS. 16A and 16B illustrate exemplary services and profile maintenance windows according to an embodiment of the invention; and

FIG. 17 illustrates a method according to an embodiment of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description.

Software Environment

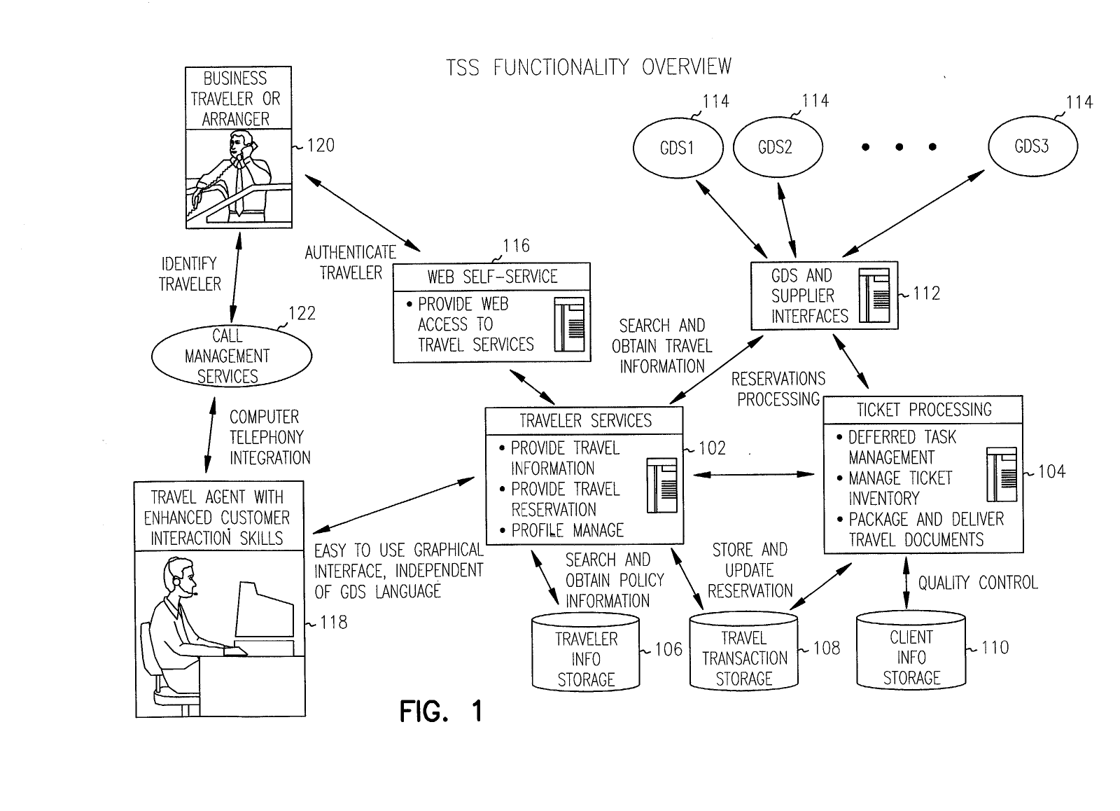

The embodiments of the invention describe a software environment of systems and methods that provide an integrated traveler service system. FIG. 1 is a diagram describing the major components of such a system. In one embodiment of the invention, the system includes a traveler services component 102, a ticket processing component 104, General Distribution Systems (GDS) 114 (also referred to as a Global Distribution System or Computer Reservation System (CRS)), and a GDS supplier interface 112. These components can be communicably coupled via various networking mechanisms known in the art, including the Internet. In addition, the system in alternative embodiments of the invention can include a call management system 122. In alternative embodiments of the invention, the system includes a web self-service component 116.

Travel services component 102 processes and maintains data related to travel service orders. This data is maintained in multiple database, including traveler information storage 106, travel transaction storage 108, and client information storage 110. Traveler information storage 110 includes traveler profile data for a plurality of travelers. Traveler transaction storage stores data related to reservation transactions requested by travelers. Client information storage 110 stores information on clients, such as contracts the clients have with preferred travel service providers, travel policies for employees etc. In one embodiment of the invention, these databases are managed by the Oracle Database Management system. However, the invention is not limited to any particular database management system. In addition, the databases 106, 108 and 110 can be combined into a single database, the invention is not limited to any particular database configuration.

Travel requests are received from travelers 120, who call into travel counselors 118 to arrange for travel related services. In one embodiment of the invention, a call management system is used to route calls to a travel counselor. In a particular embodiment of the invention, the call management system is the Geotel system. Travel services component 102 provides a user interface for travel counselor 118 to enter data received from the traveler, and to obtain data from the database and/or GDS systems 114.

GDS 114 is a distribution system designed to inventory and record reservations of travel related services. Examples of such systems are known in the art and include the Sabre system from the Sabre Group, Inc, and the Apollo system, also known as FocalPoint, from Galileo, Inc.

In some embodiments of the invention, travel component 102 communicates with GDS 114 through a GDS and Supplier interface 112. In one embodiment of the invention, the GDS and Supplier interface is the Equant interface.

Ticket processing component 104 communicates with databases 108 and 110, and GDS 114 through interface 112 to process ticket requests and to handle and manage deferred tasks. Ticket processing component 104 also handles the packaging and delivery of travel documents such as tickets and itineraries using data in databases 106, 108 and 110.

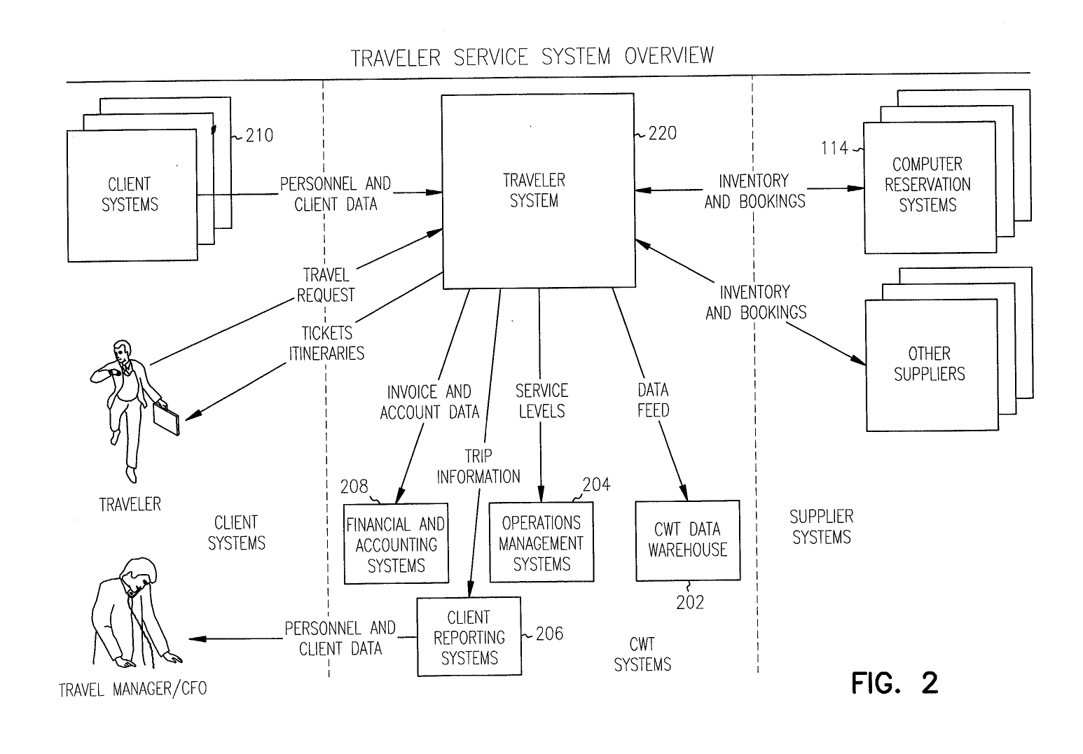

FIG. 2 provides an overview of further components and systems that can be included in a traveler service system according to an embodiment of the invention. The additional components comprise financial systems 208, operations management system 204, data warehouse 202, reporting systems 206, and travel client systems 210. Financial systems 208 can receive invoice and account data used to bill travel clients for services and tickets provided by the travel service supplier. Reporting systems 206 operate to generate reports on travel and reservation activity for use by travel clients. Client systems 210 can provide data to the system. For example, client systems can provide human resources data such as employee names and department identifiers that can be stored in databases 106, 108 or 110. In addition, client systems 210 can provide contract information regarding a client's contract with various travel service suppliers. Again, this information can be stored in databases 106, 108 or 110.

This section has described the various software components in a system that provides a graphical user interface for accessing multiple travel suppliers. As those of skill in the art will appreciate, the software can be written in any of a number of programming languages known in the art, including but not limited to C/C++, Visual Basic, Java, Smalltalk, Pascal, Ada and similar programming languages. In addition, the system can use various development environments, such as the Forte development environment. The invention is not limited to any particular programming language or environment for implementation. Furthermore, the above-described components can be implemented in a single computer system, they can be implemented in a client/server environment, or they can be implemented across a plurality of computer systems. The component software can reside on computer-readable media such as RAM, ROM, CD-ROM, DVD-ROM, floppy disks, tape media, or computer hard drives. Furthermore, the computer-readable media can comprise signal on a wired or wireless network. The invention is not limited to any particular computer-readable media.

Software Environment

The previous section provided a component level overview of the various embodiments of the invention, this section provides details on the data and interfaces, including user interfaces, provided by the various embodiments of the invention.

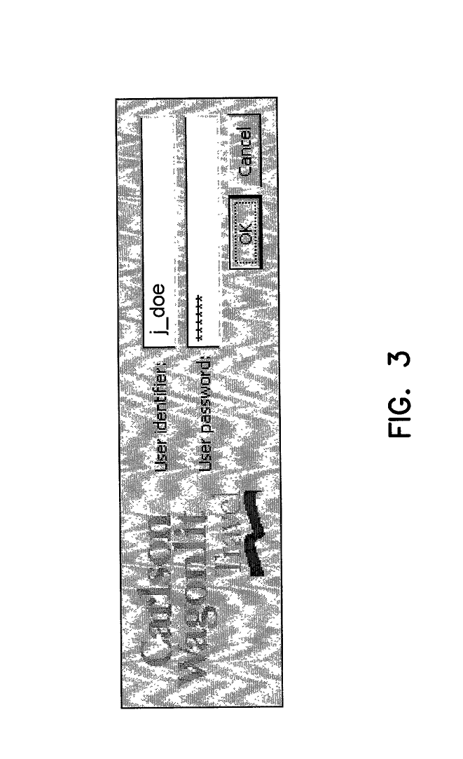

An exemplary login screen is shown in FIG. 3. The login screen illustrated provides input fields allowing a user to enter a user id and a password. The user id can be associated with certain skill levels and access rights.

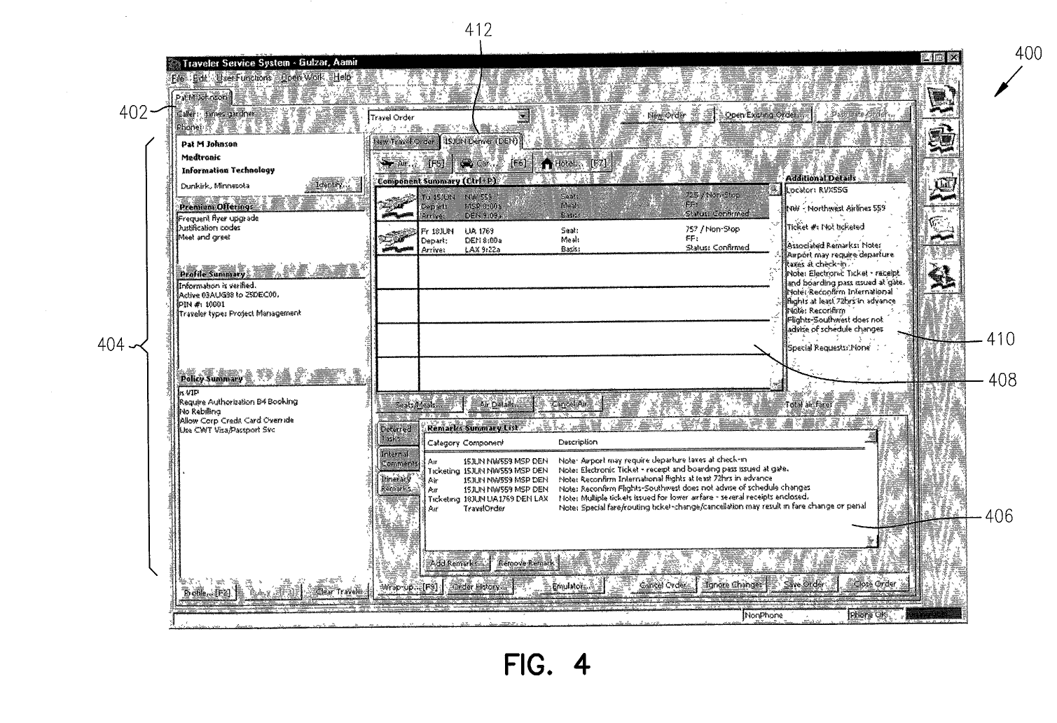

FIG. 4 is an exemplary image of a main itinerary window 400 that is displayed to a user upon a successful login. Main itinerary window 400 includes traveler tab 402, traveler information area 404, supplemental information area 406, component summary area 408, additional details area 410, and travel order tabs 412. Each of the areas displayed on the window 400 can be made context sensitive, that is, the content displayed in the window is dependent on selections made from other windows.

In one embodiment of the invention, the navigation hierarchy of the main window and the windows described below includes a tabbed entry for one or more travelers, with each traveler having a profile, and travel orders. Each travel order can include reservations for air travel, car rental, and hotel rooms. In addition, alternative embodiments of the invention can provide for other types of reservations, including rail travel, limousine, tour, cruise, meeting room, golf tee times and restaurant reservations etc. The invention is not limited to any particular type of reservation service.

In the example shown, the current user interface displays one traveler, “Pat M. Johnson”. However, the invention is not limited to single travelers. One tab per traveler will appear in the window 400, selection of a tab causes details for that traveler to appear in the window 400.

Similarly, a traveler can have multiple travel orders pending for current and future travel. Selecting a travel order tab 412 will cause details for the particular travel order to appear in window 400.

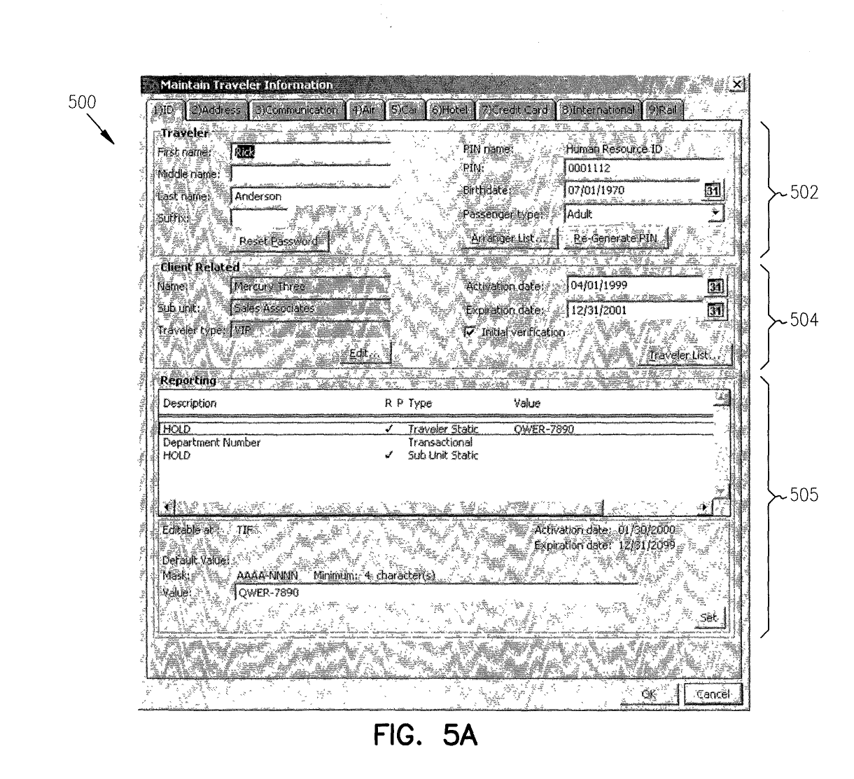

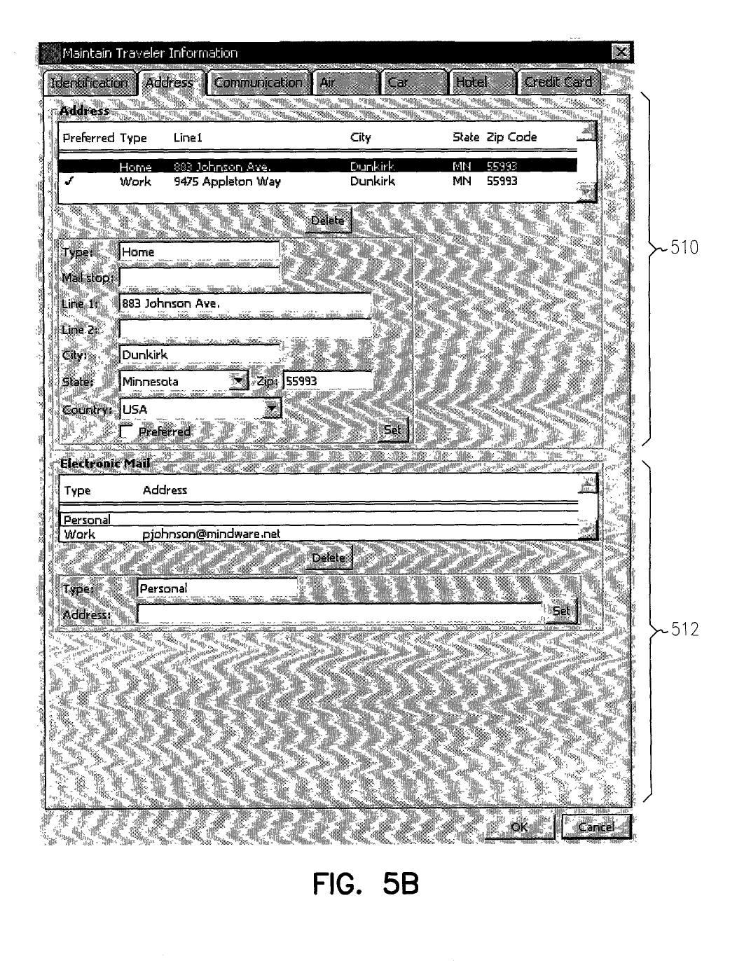

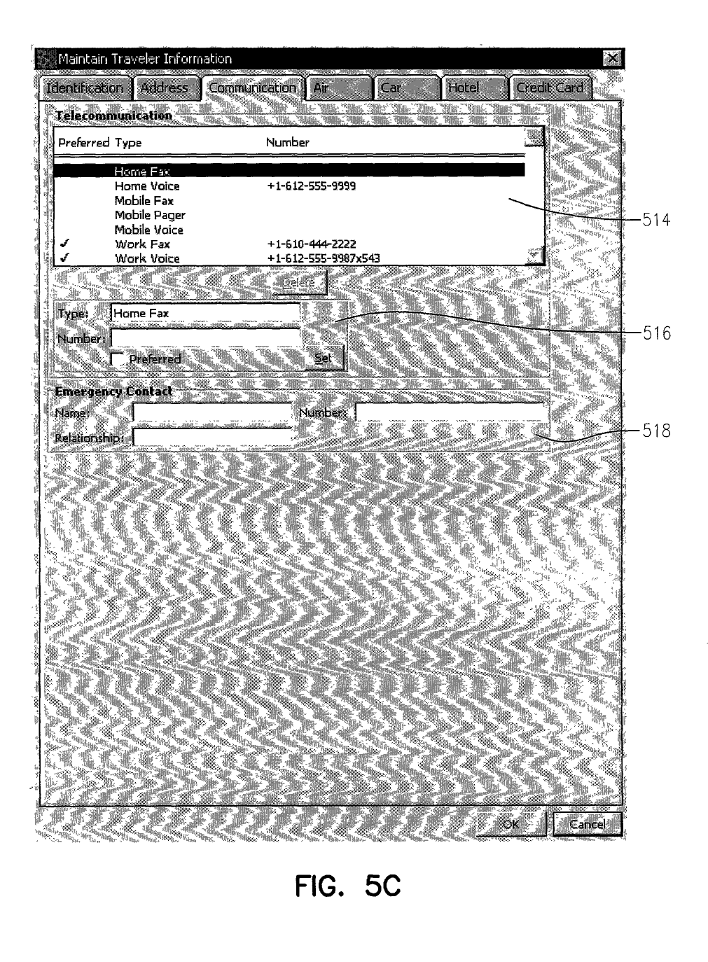

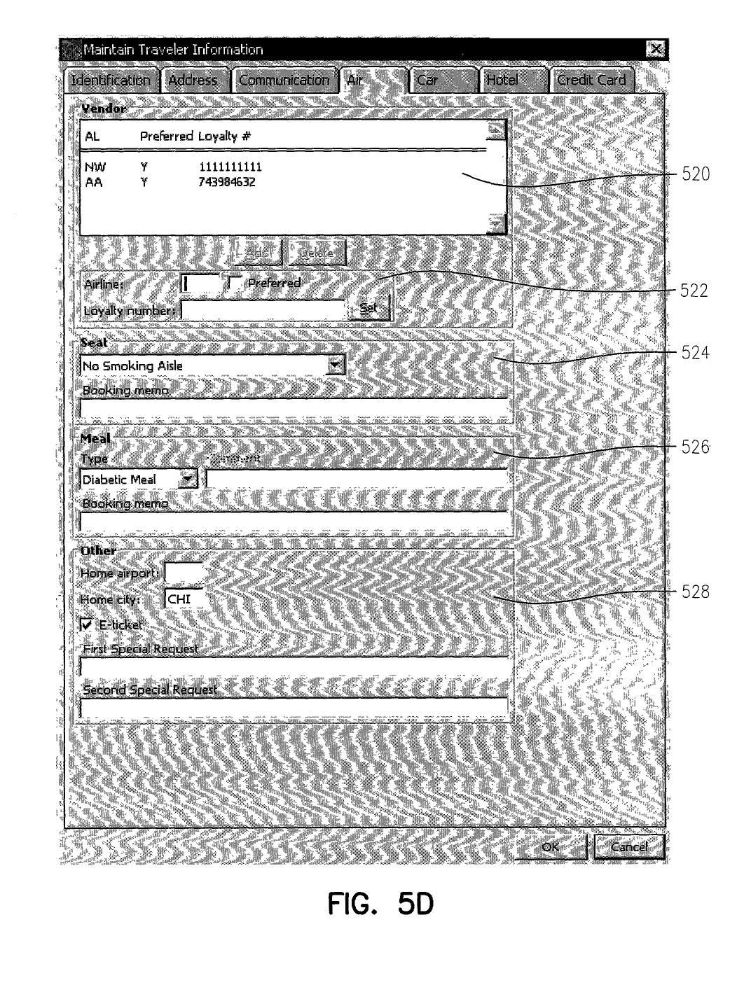

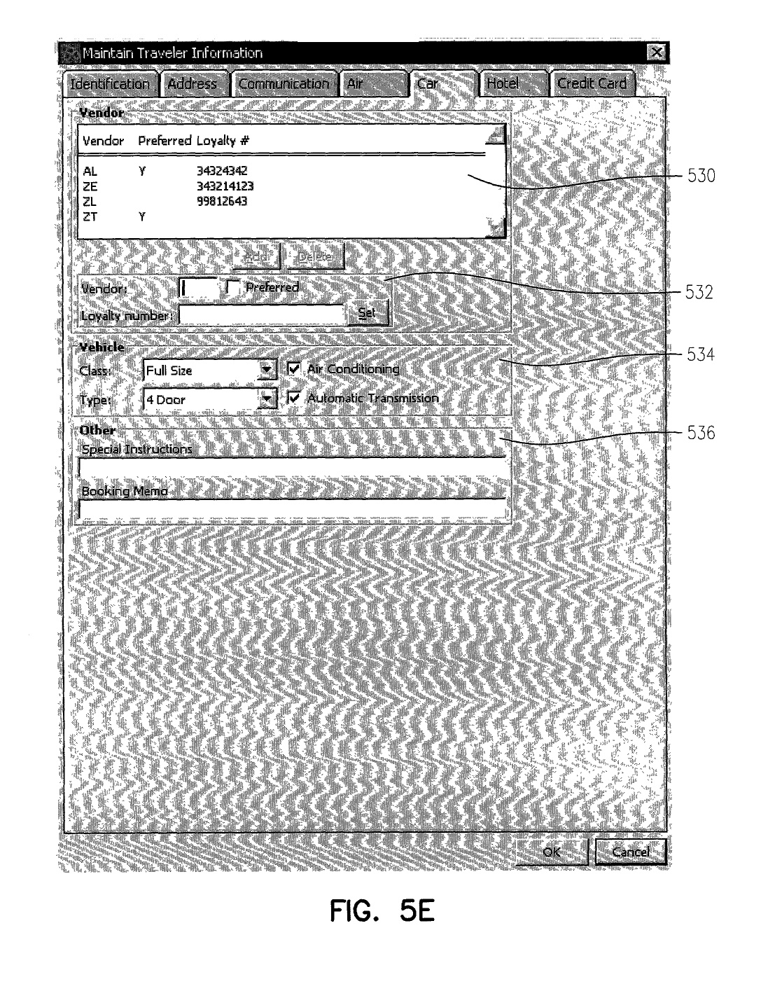

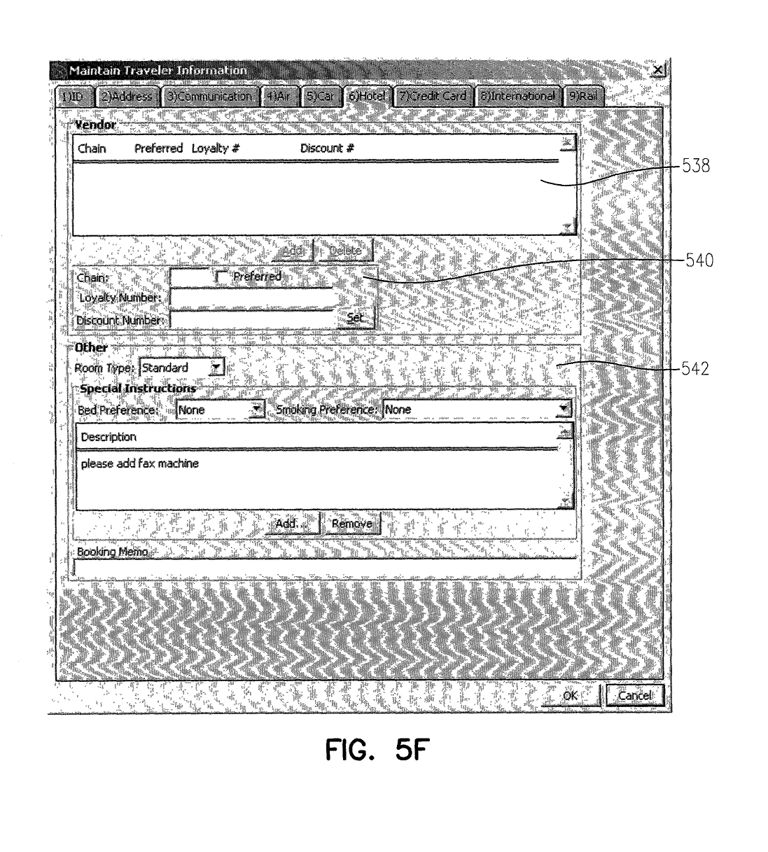

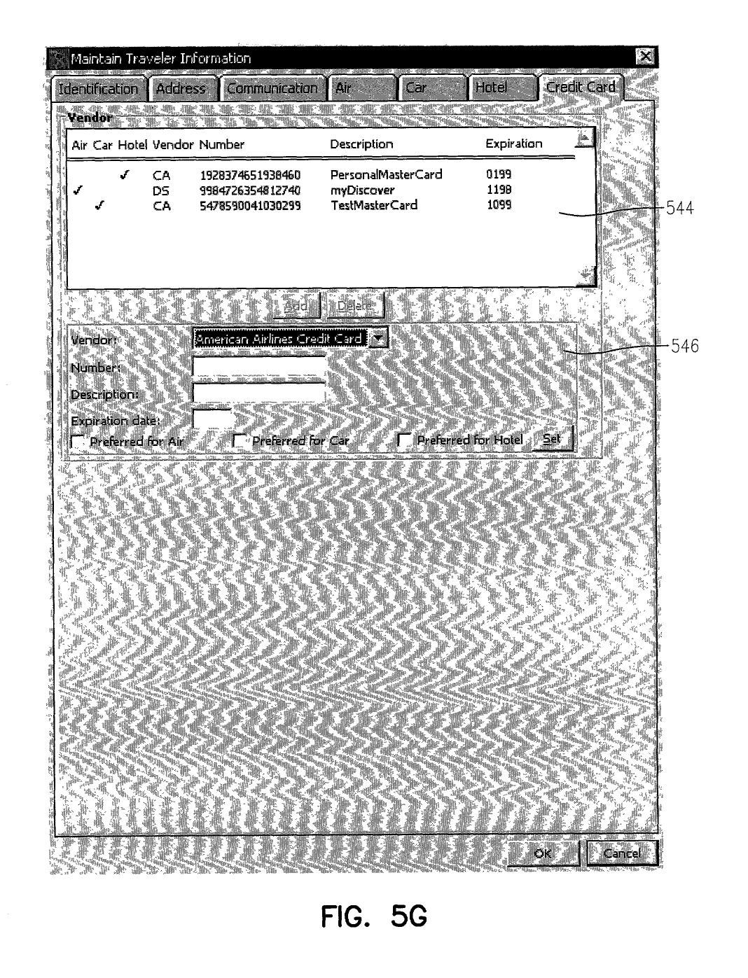

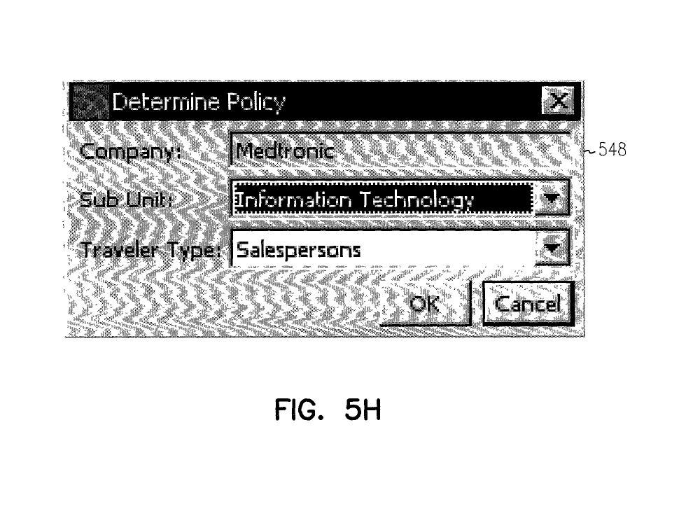

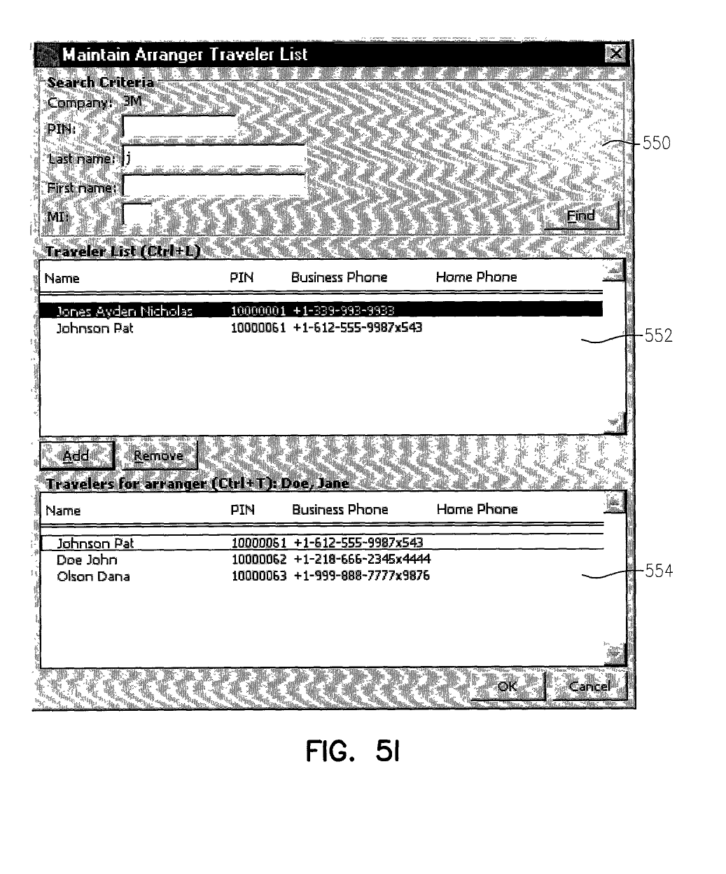

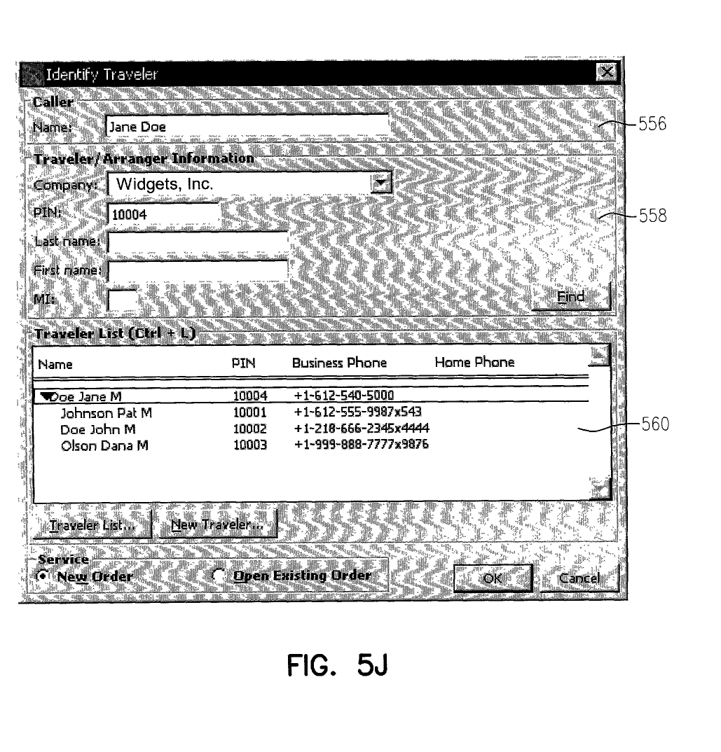

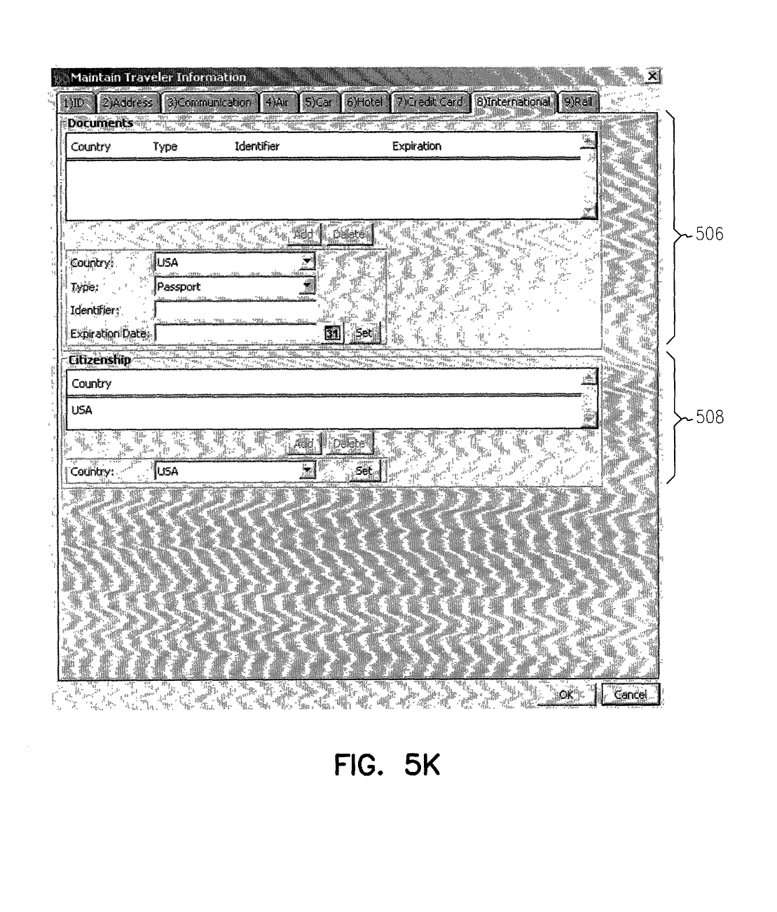

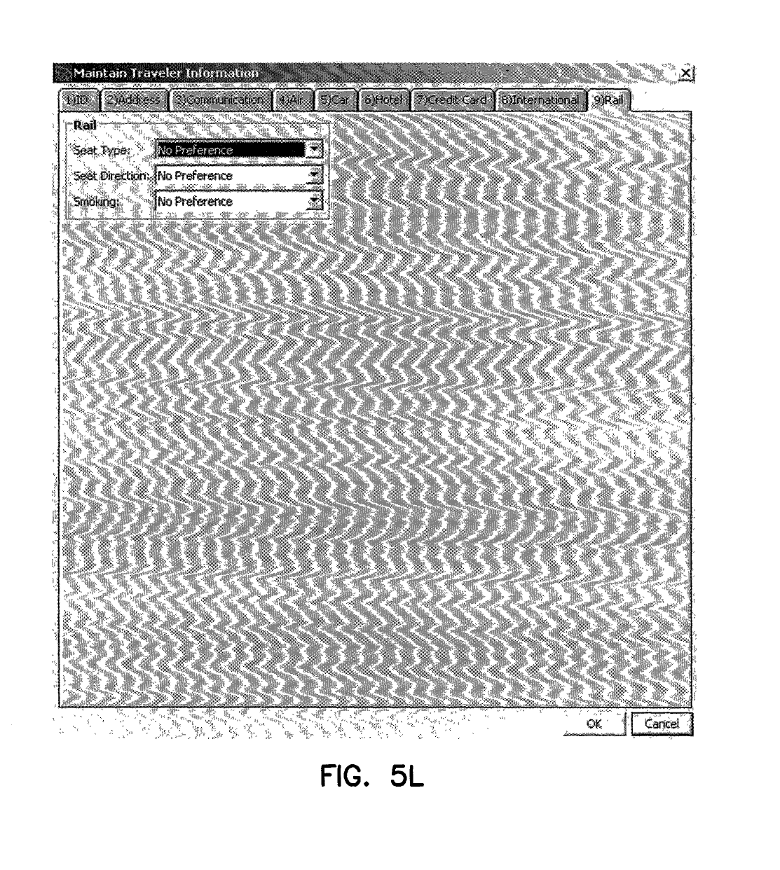

FIGS. 5A-5L describe windows according to an embodiment of the invention that provide for the creation and maintenance of a traveler profile. Various data item regarding a traveler are maintained by the system for use in identifying a particular traveler's preferences and for automatically supplying information that can be used during the reservation process.

FIG. 5A illustrates a main traveler identification window 500 according to an embodiment of the invention. Window 500 includes traveler biographical data 502, client data 504 and report fields 505. In one embodiment of the invention, biographical data 502 includes the name, birth date, passenger type, and personal identification number (PIN) of the traveler. The PIN is a unique identifier assigned by the system to the traveler in order to uniquely identify the traveler in the database. In one embodiment of the invention, the PIN must be unique within all travelers that use a particular “800” telephone number to call to make travel arrangements.

Client data 504 includes data that identifies a client of the travel service provider. Typically, the client will be a business that makes travel arrangements for its employees through the travel service provider. The business name, division or sub unit, traveler type, activation date, and expiration date is maintained by the system in one embodiment of the invention. The traveler type can be used to designate different rules to be followed by the system and system users when making travel arrangements for a particular traveler. For example, a company executive traveler type may be allowed to fly first class, while company sales staff may be required to fly coach class. The traveler type can be used to identify rules to be applied to such groupings of client personnel.

Report fields 505 comprise user-specified fields that can be traveler specific, or they can be corporation specific. In one embodiment, the fields have description labels, types and values. The field types can describe whether the fields are relatively static, or if the fields change with each travel order or transaction. Report fields can be sent to backoffice systems such as reporting component 206 and can be included on reports provided to customers. Providing reporting fields is desirable because it allows clients to receive customized reports that can be organized and that can contain data that is more meaningful to the client than would be available through a more generic report.

An exemplary window for maintaining traveler address information for the currently selected traveler is illustrated in FIG. 5B. Included are both physical address information 510, and electronic mail address information 512. Physical and electronic mail addresses for both home and work can be maintained, along with a preference indicator that can be used to indicate where the traveler prefers to receive physical and electronic mail.

An exemplary window for maintaining traveler communications data is illustrated in FIG. 5C. Telecommunications data 514 includes voice, fax, pager, and mobile phone numbers for the traveler. In addition, particular numbers can be selected as being preferred contact numbers for the traveler. Data on a selected number can be maintained by selecting a particular number from window 514 and updating the data in edit box 516.

Emergency contact information for the traveler can be provided in emergency contact area 518.

An exemplary window for maintaining air travel preferences is illustrated in FIG. 5D. Vendor area 520 provides a list of airlines used by the traveler, including any loyalty program (i.e. frequent flyer program) member numbers for the traveler and an indicator of whether or not the traveler prefers to use the airline. In addition, seating preference 524, meal type 526, and home city and airport 528 can also be specified and maintained by the system. Airline vendor information can be added or modified using edit box 522.

An exemplary window for maintaining car rental preferences is illustrated in FIG. 5E. Vendor area 530 provides a list of car rental service providers used by the traveler, including loyalty program membership numbers and an indicator of whether or not the traveler prefers to use the car rental service provider. Car rental vendor information can be added or modified using edit box 532. Vehicle preference area 534 allows a user to enter vehicle characteristics regarding the type of vehicle the traveler prefers to rent. Special instructions area 536 provides an interface for entering free-form text describing any other special car rental requests for the traveler.

An exemplary window for maintaining hotel preferences is illustrated in FIG. 5F. Vendor area 538 provides a list of hotels used by the traveler, including whether or not the traveler prefers the hotel. In addition, loyalty program membership and discount numbers can be maintained and displayed by the system. Hotel preference data can be entered and updated using edit box 540. Other information area 542 can be used to specify additional instruction regarding the traveler's preferences, including the room type, bed size, non-smoking room preference and other special requests for the traveler.

An exemplary window for maintaining credit card information for the traveler is illustrated in FIG. 5G. Credit card vendor list 544 provides a list of the traveler's credit cards, including the credit card number, credit card description, and expiration date for the credit card. Also included are indicators of the type of reservation charged to the card, thereby allowing the traveler to specify different cards depending on whether an air, car, or hotel reservation is being made. Edit area 546 provides an interface for adding and updating credit card information appearing in vendor list 544.

An exemplary traveler policy window 548 is illustrated in FIG. 5H. Window 548 provides an interface for updating the unit and traveler type for the traveler. As noted above, a unit or traveler type can be used by the system to establish constraints on the type of travel reservations that should be made for a particular traveler.

In some embodiments of the invention, travelers can be associated with a travel arranger. A travel arranger is typically a representative of a client company that makes travel arrangements on behalf of one or more travelers. An exemplary traveler association window for creating and maintaining associations between a traveler and a travel arranger is illustrated in FIG. 5I. The exemplary window includes search criteria area 550, traveler list 552, and associations list 554. Search criteria 550 provides an interface for inputting search parameters. In one embodiment of the invention, the search parameters can include last name, first name, middle initial, and PIN. If associating travelers with an arranger, the window title shows “Maintain Arranger Traveler List” and the search criteria is for travelers. If associating arrangers for a traveler, the window title shows “Maintain Traveler Arranger List” and the search criteria is for an arranger. In either case any traveler can be assigned as an arranger. The existence of the relationship with travelers defines an arranger.

Traveler list 552 provides a list of travelers that match the search criteria. Associations list 554 provides a list of travelers that have been associated with a particular travel arranger. In one embodiment of the invention, travelers can be selected from the traveler list and added to the associations list 554, and travelers in the associations list 554 can be removed from the association.

An exemplary identify traveler window is illustrated in FIG. 5J. The exemplary window includes a caller identification 556, a traveler arranger area 558, and traveler list 560. The caller identification 556 is used to input the name of a person calling to make travel arrangements. The system searches for a match on this information, and presents details regarding the client company, if any, in traveler arranger area 558. If the caller is a travel arranger for one or more travelers, the list of travelers appears in traveler list 560. In one embodiment of the invention, the list includes drop-down capability. Selecting a travel arranger causes a list of travelers associated with the arranger to “drop down”. The particular traveler that the travel arranger is calling on behalf of can then be selected from the traveler list, and the main window 400 will be updated to reflect the selection.

An exemplary international data window is illustrated in FIG. 5K. The exemplary window includes identification documents data 506 and citizenship data 508. Identification documents data area 506 can be used to list the details regarding identification documents possessed by the currently selected traveler. Typically, this will include a passport, however other identification documents can also be maintained. Citizenship data area 508 provides data regarding the citizenship of the currently selected traveler.

An exemplary rail travel window is illustrated in FIG. 5L. In one embodiment, the rail travel window includes mechanisms such as drop down boxes allowing a user to specify preferences regarding the seat type, the seat direction (e.g. rearward or forward facing) and whether the traveler prefers a non-smoking or smoking permitted seat.

This section has described systems, methods, and interfaces for maintaining traveler information, including biographical and preference information. The next section describes systems, methods and interfaces related to airline reservations for a traveler.

Air Travel Components

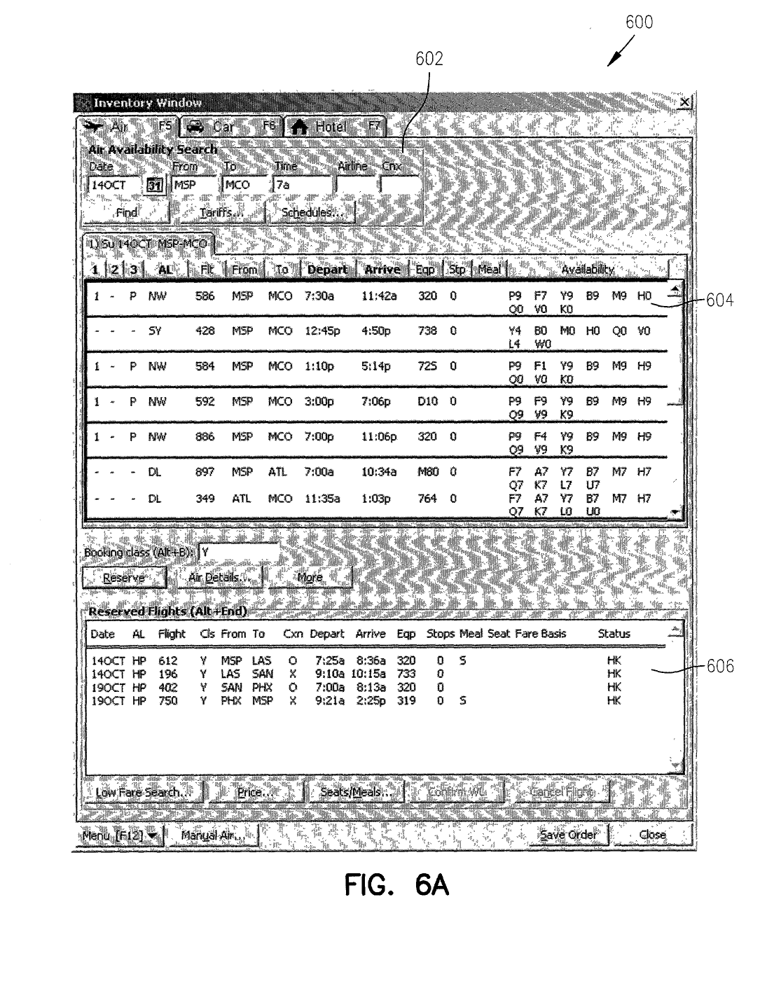

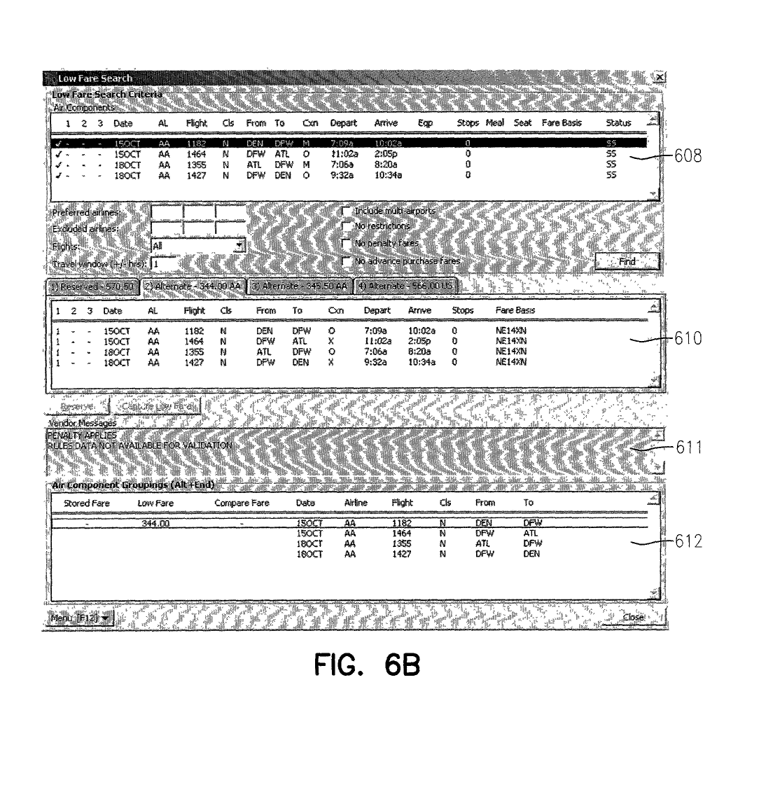

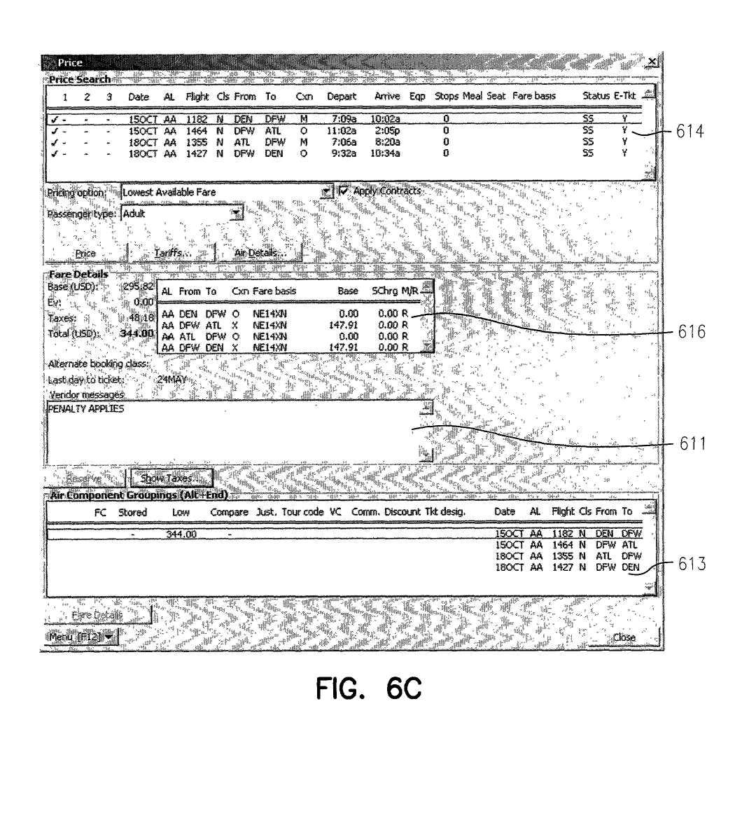

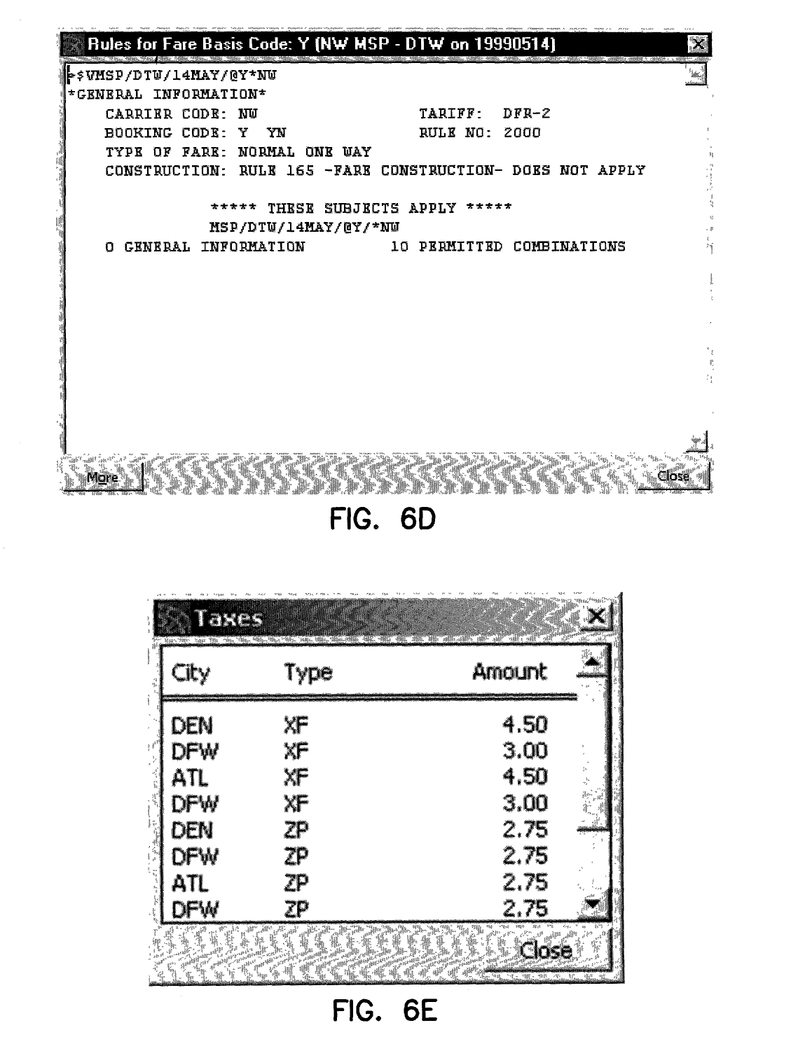

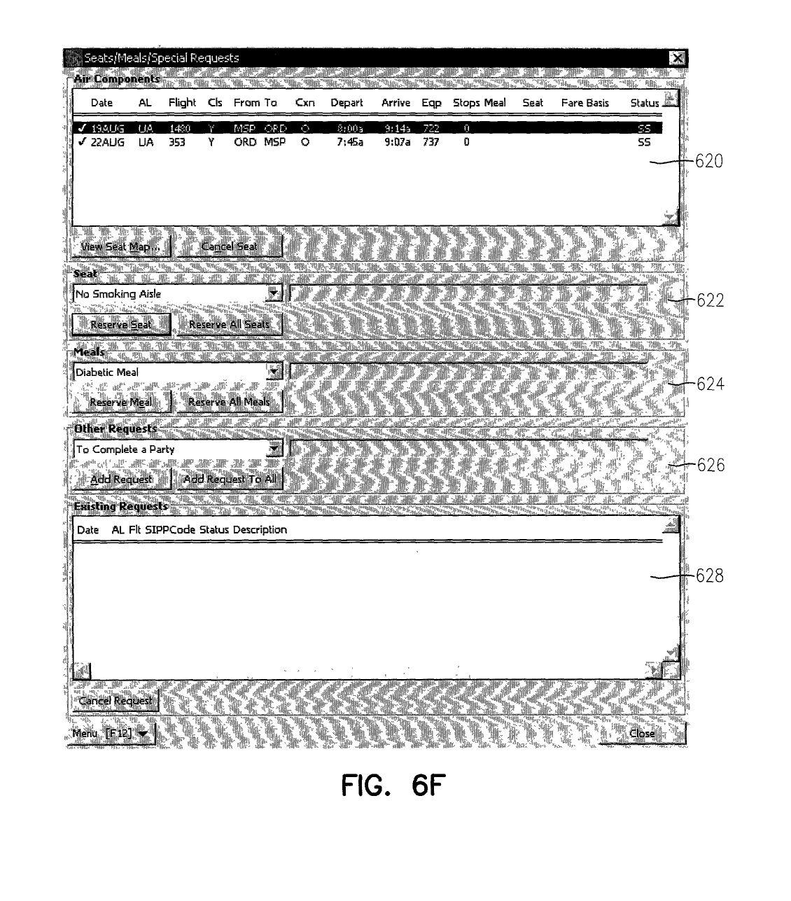

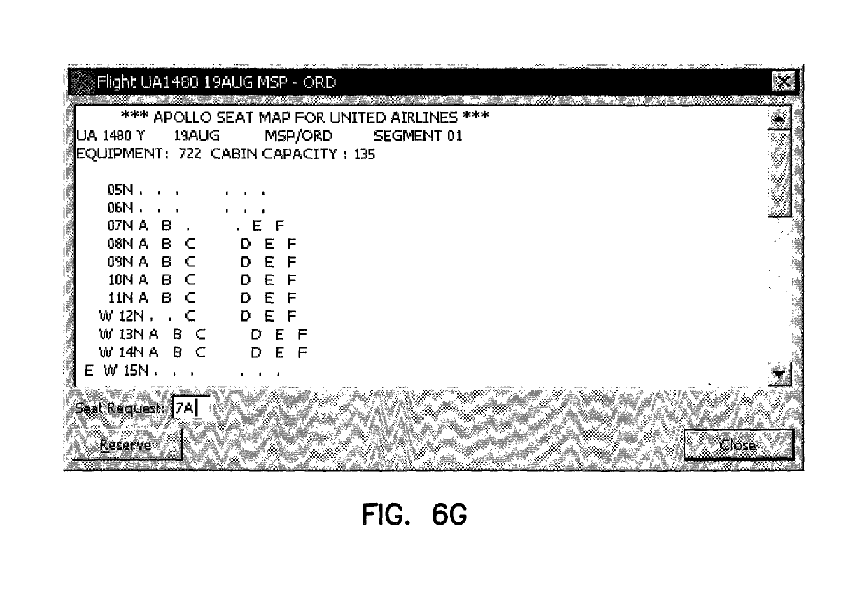

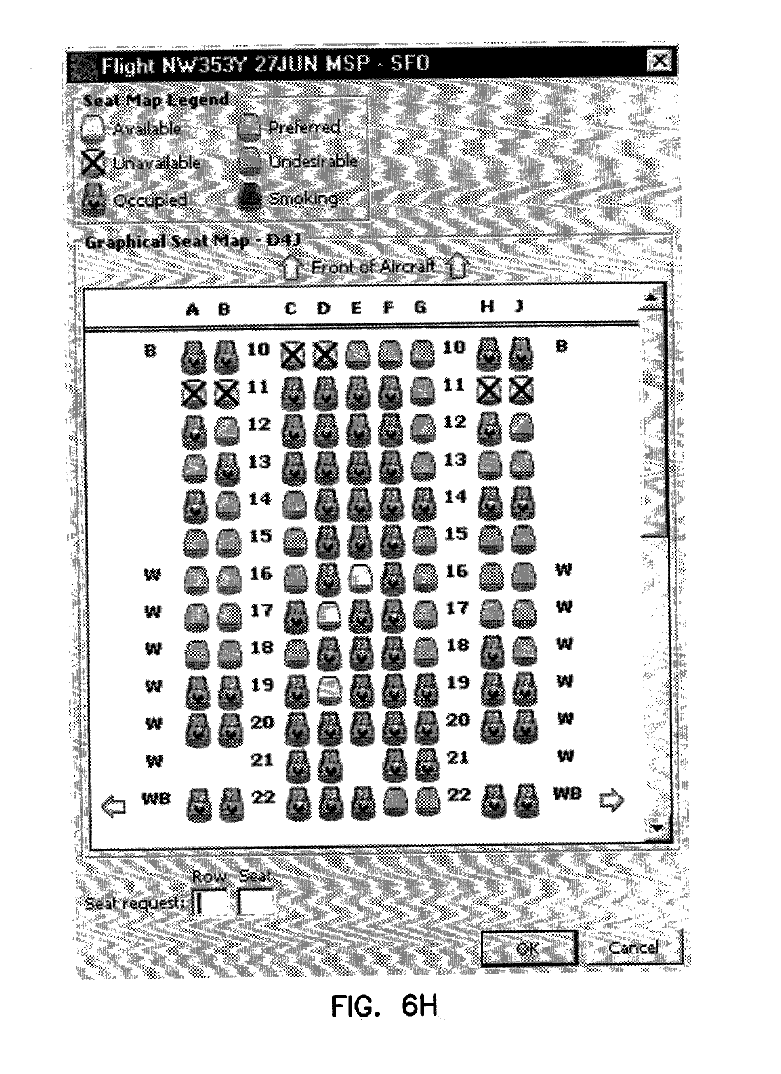

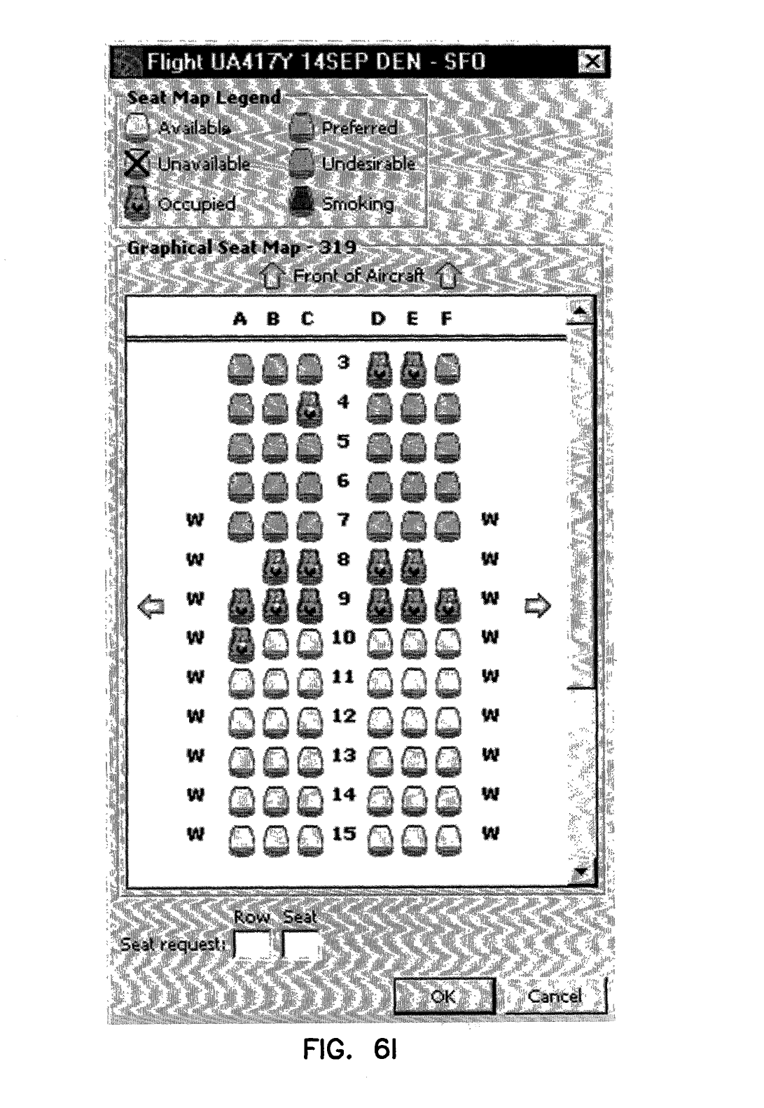

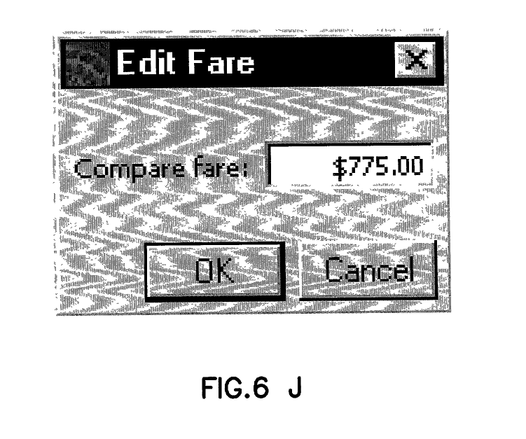

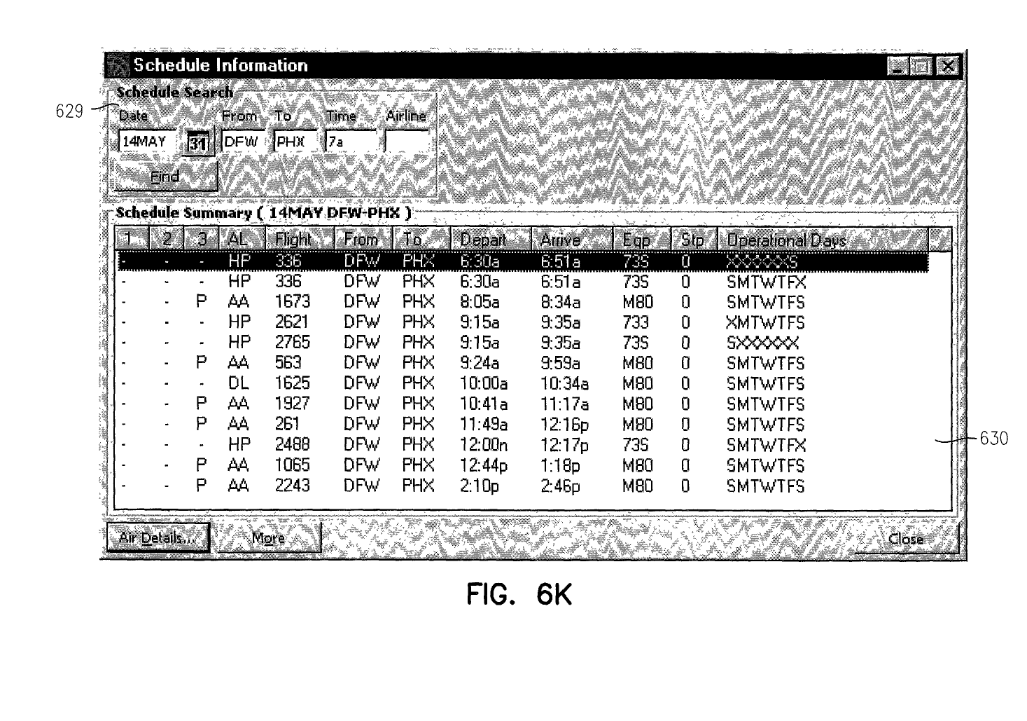

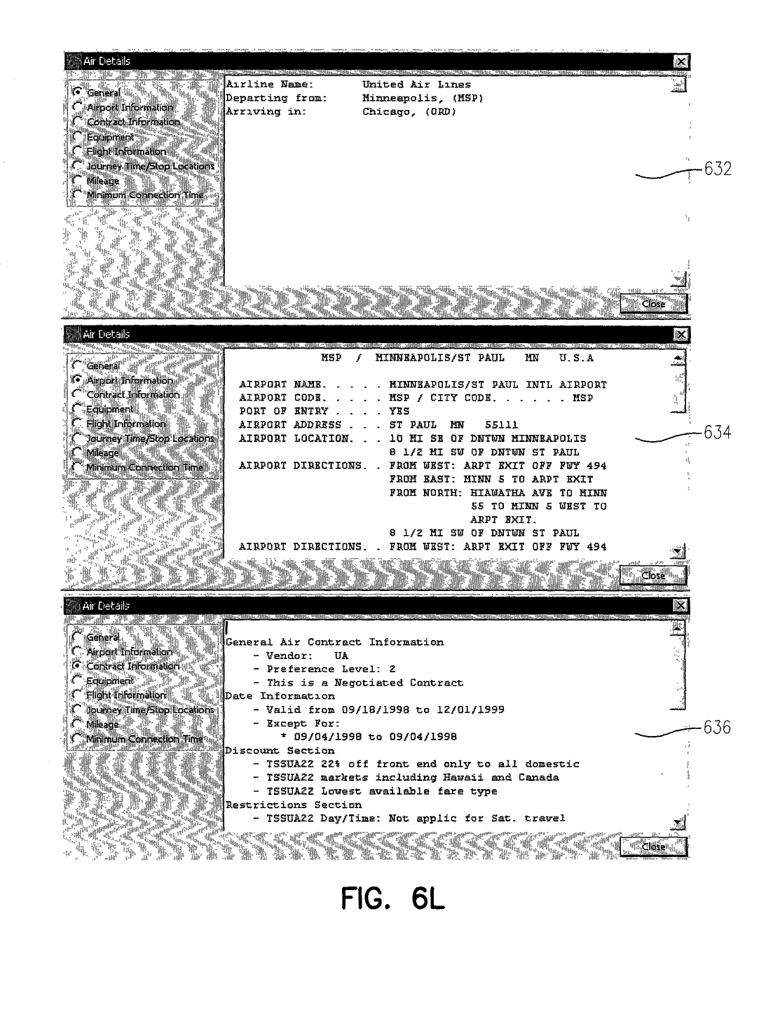

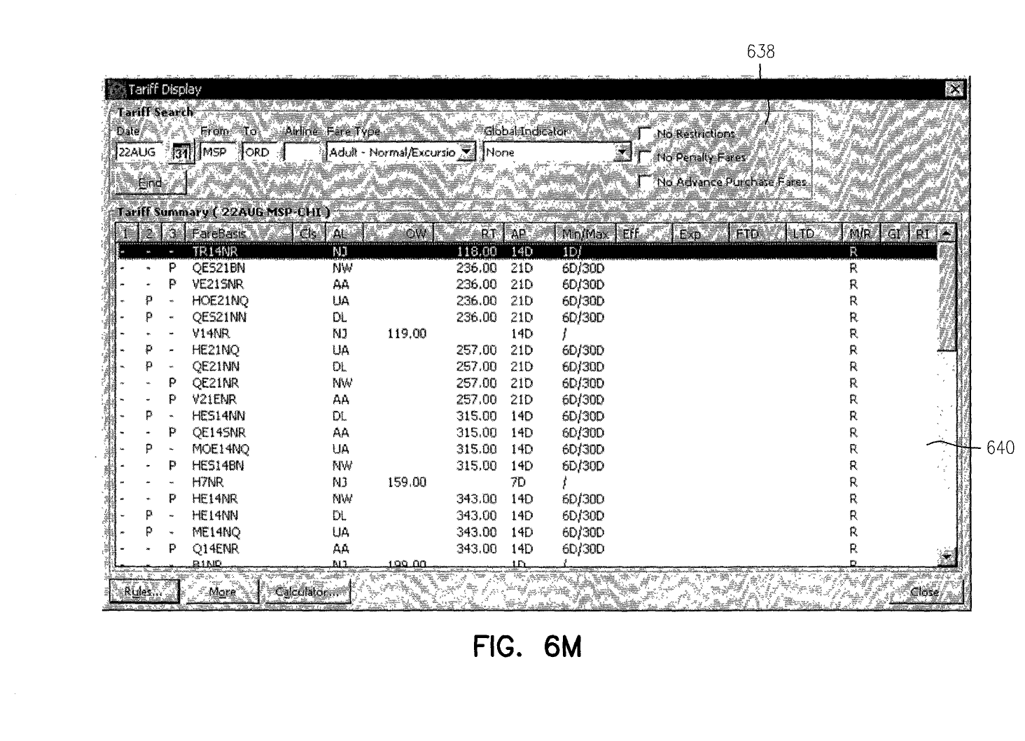

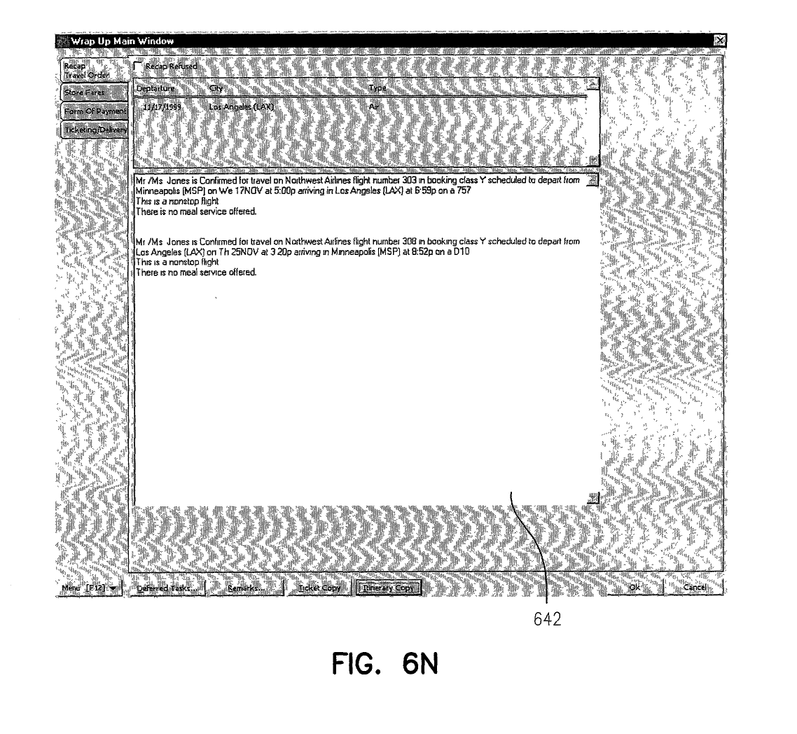

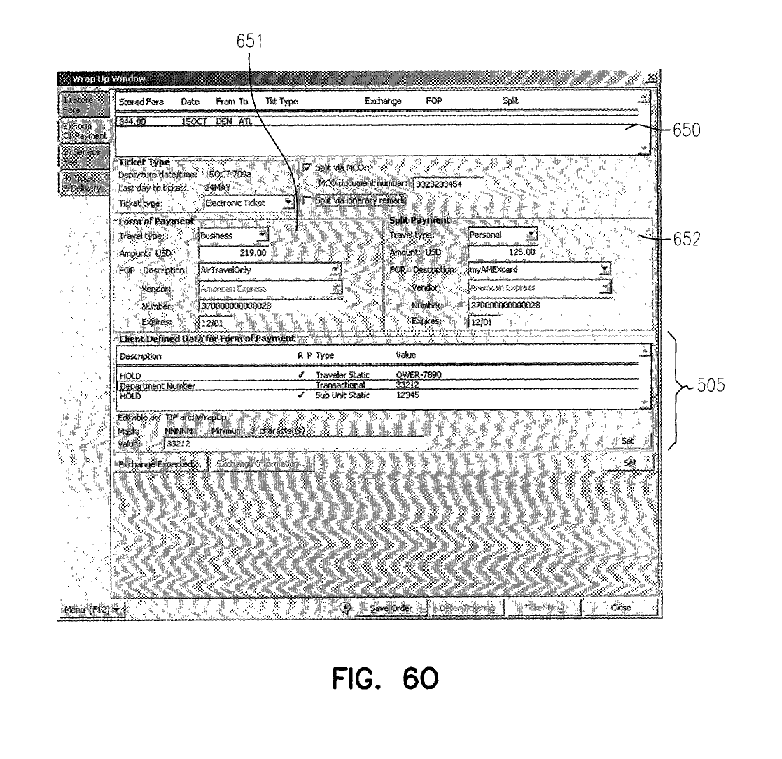

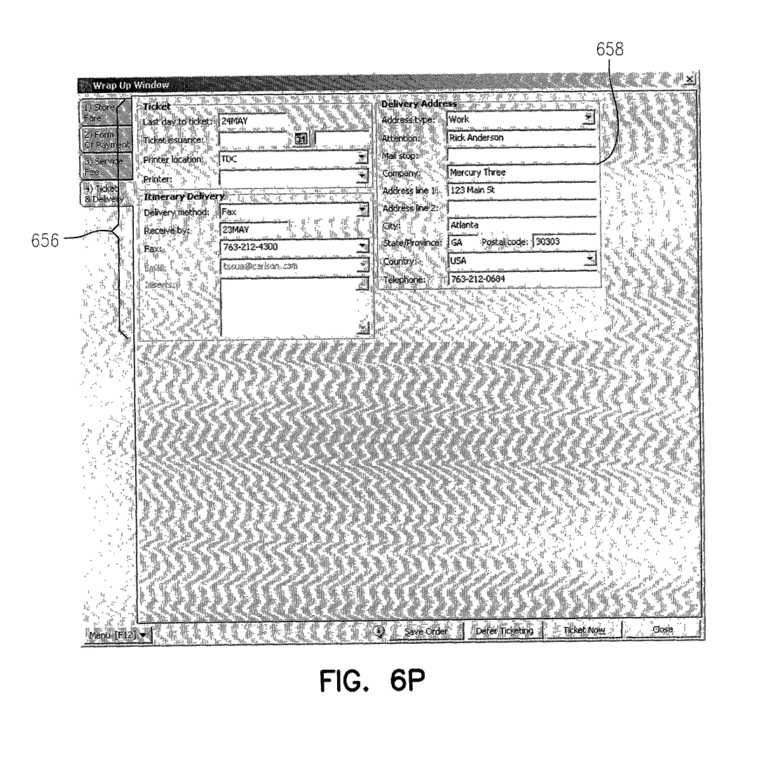

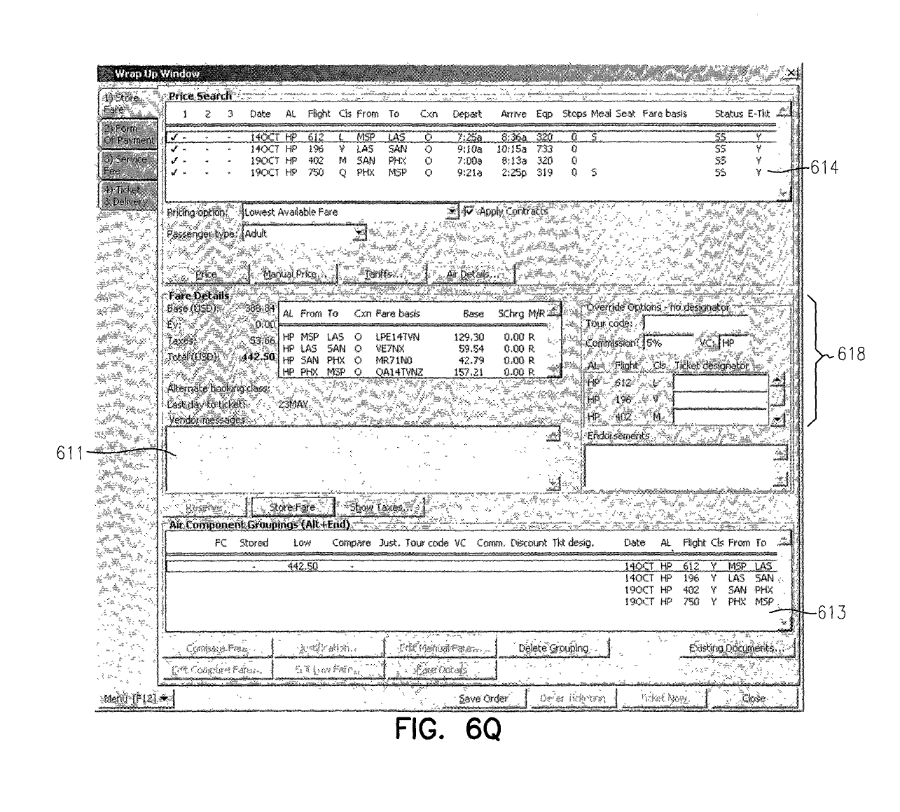

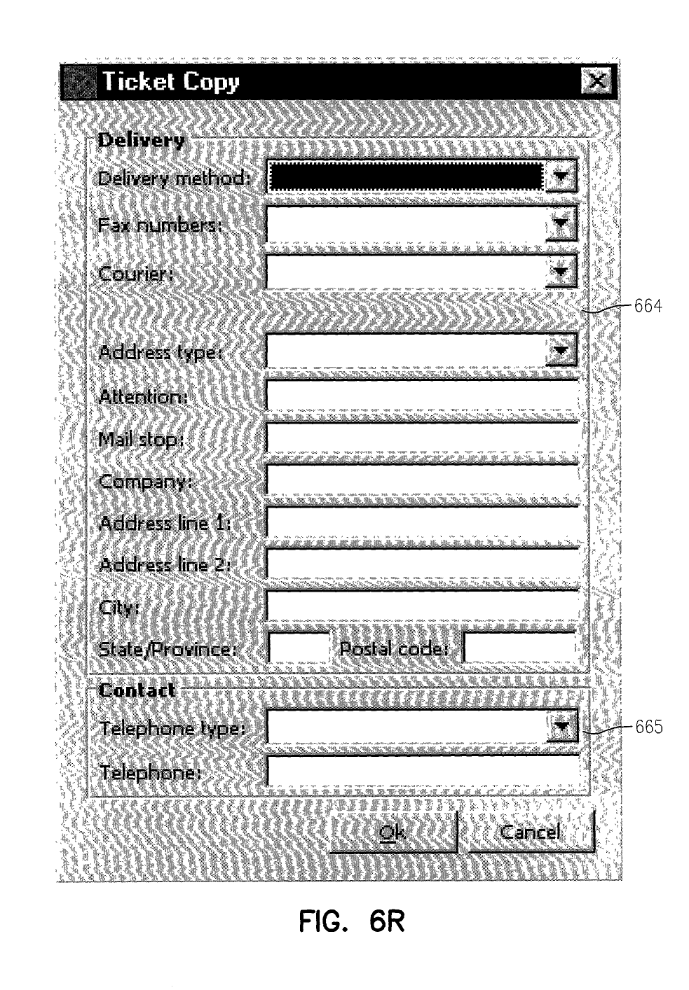

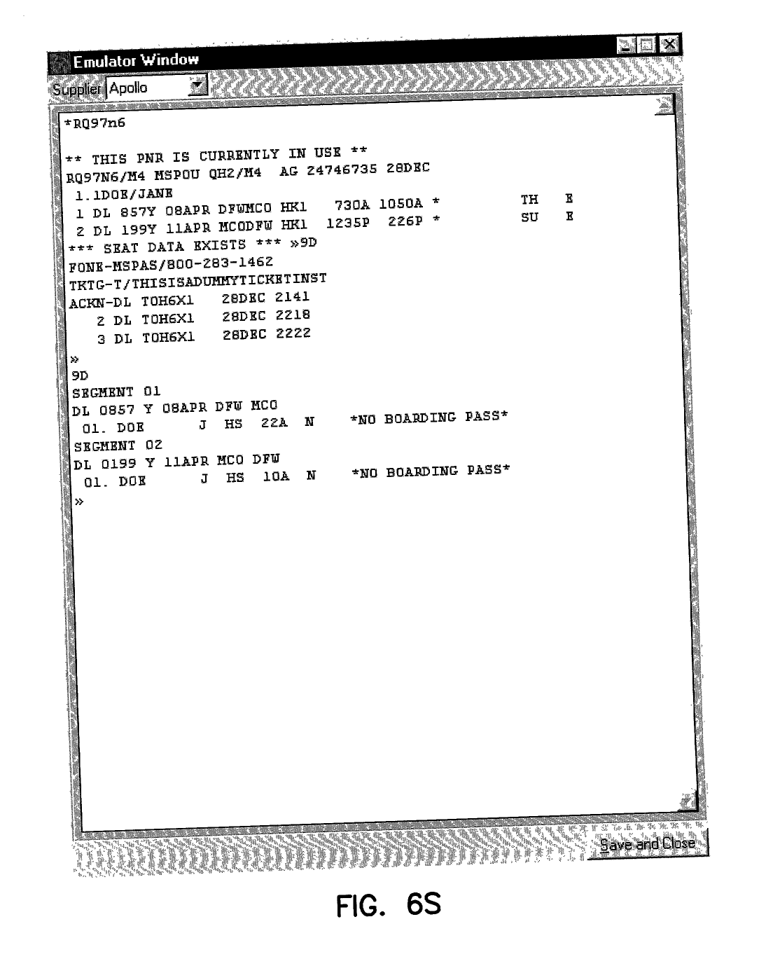

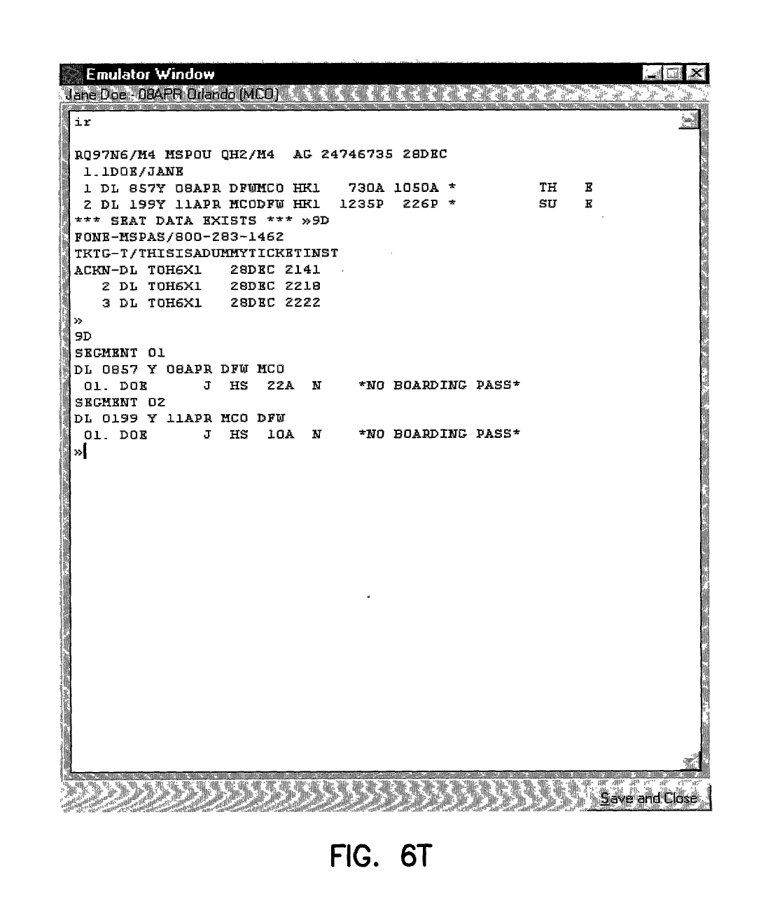

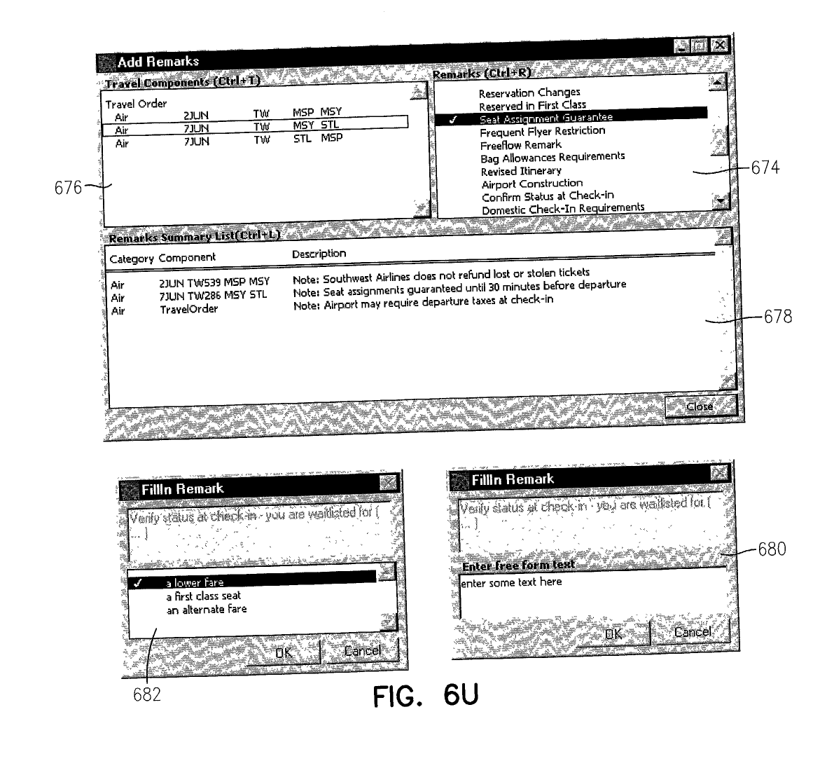

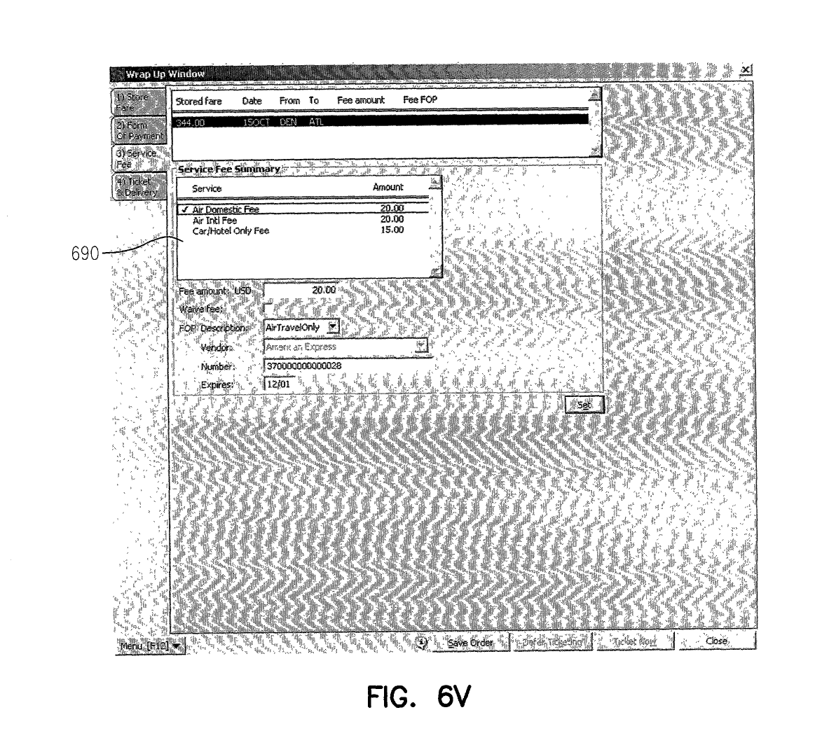

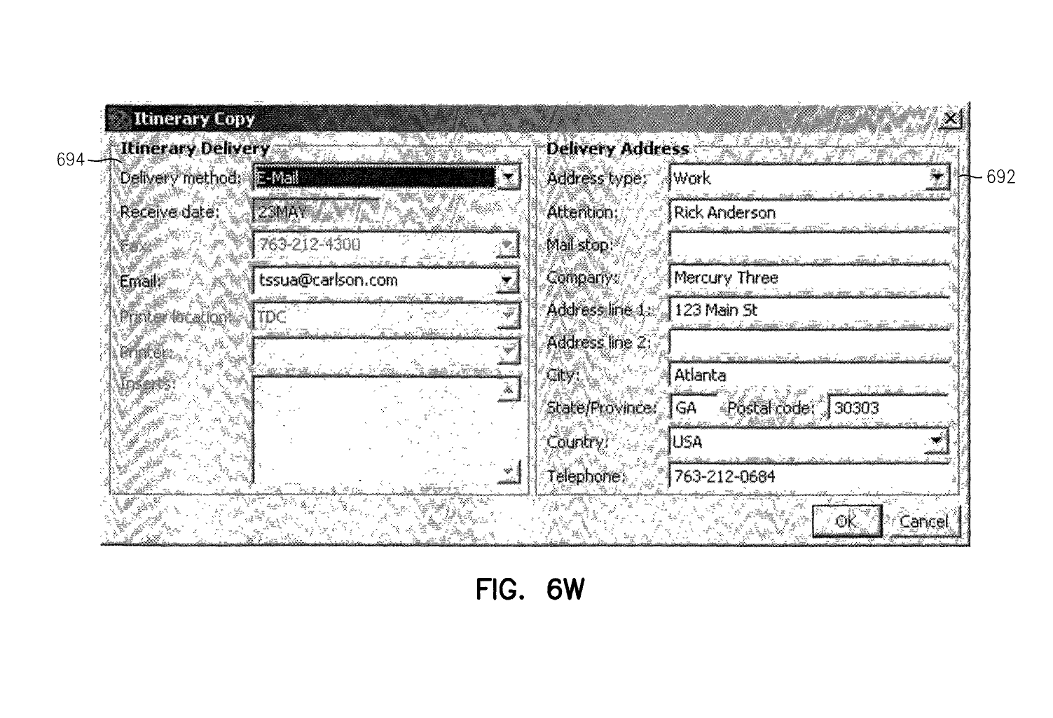

An exemplary air inventory window 600 is presented in FIG. 6A. In one embodiment of the invention, window 600 includes search parameters 602, inventory list 604, and reservation list 606. Search parameters 602 provide an interface for entering search criteria to be used in selecting inventory for display in inventory list 604. The search criteria can include the date, from airport, to airport, time, airline, and connection airport. In an alternative embodiment of the invention, an inventory list is produced for each travel day in the current travel order. In one embodiment of the invention, the inventory list produced by the system includes the following data as shown by the column labels in inventory list 604:

1- An indicator whether the client company prefers the airline, perhaps due to a contract between the airline and the client company giving preferred rates to the client.

2- An indicator whether the travel service provider prefers the airline due to the availability of a contracted rate.

3- An indicator whether the traveler prefers the airline, as read from the travelers profile data described above.

AL Airline code

Flt Flight number

From Source Airport

To Destination Airport

Depart Departure time

Arrive Arrival time

Eqp Equipment type

Stp Number of stops between source airport and destination airport

Meal Type of meal served on the flight.

Availability Seat class and number of seats available within that class

In one embodiment of the invention, airlines that are indicated as preferred according to the travelers preference or according to corporate policy are highlighted.

Reservation list 606 provides a list of flights currently reserved. Flights can be added to the list 606 by selecting the desired flight from inventory list 604. In one embodiment of the invention, reservation list 606 provides much of the same information above, and additionally can include the fare basis and reservation status received from a GDS.

An exemplary low fare search window is illustrated in FIG. 6B. The exemplary window includes a low fare search criteria area 608, a fare comparison area 610, a vendor message area 611 and an air component grouping window 612. Search criteria 608 provides a mechanism for inputting search criteria used to limit the low fare search to particular dates, airlines, flights, times and ticket purchase rules. A set of flights that meet the search criteria having the lowest fares is presented in fare comparison area 610.

Vendor message area 611 provides a mechanism for displaying messages related to a particular vendor for a travel service. Typically the vendor message area will display rules that apply to a selected vendor's fare. For example, the fare may be non-refundable, require a certain stay, or there may be a penalty for itinerary changes.

The component grouping window 612 provides summary information, including the currently stored fare, the low fare found as a result of the search, and the compare fare (i.e. the lowest price coach fare with no restrictions). A component grouping provides a mechanism for selecting the flights that will be priced and ticketed together. All flights do not have to be from the same ticket book. Often airlines give better fares if only their vendor is used on a ticket. Thus it is desirable for travel counselors to issue more than one ticket. Each ticket is a component group, hence more than one component grouping is possible for a particular travel order.

In some embodiments of the invention, clients can choose to exclude certain air vendors when searching for flights. Since travelers may be penalized for not reserving the lowest fare in the market selected, the client reporting may be misleading when an undesirable carrier offers the lowest fare. The client can set up a policy item to list air vendors they wish to omit from low fare search results, therefore excluding them from the lowest fare comparison data.

In further alternative embodiments, clients may not require their travelers to take connecting flight. If a flight with a connection is the lowest fare in the traveler's market then reporting can be misleading. The feature, also controlled by service and policy settings as described below, allows low fare search results to omit connecting flights.

An exemplary price window according to an embodiment of the invention is presented in FIG. 6C. The exemplary window includes a pricing option area 614 listing details regarding the currently selected flights, fare details area 616, and component grouping area 613. Fare details area 616 provides fare information regarding the currently selected flights, including the fare basis, taxes and tariffs, and the last date to purchase a ticket at the indicated fare. Component grouping 613 displays a summary of the component groups being priced.

FIGS. 6D and 6E are illustrations of exemplary windows that provide the rules for being eligible for the fare on the selected flight, and the taxes applied to flights through selected airports respectively.

FIG. 6F provides an illustration of an exemplary request window according to an embodiment of the invention. The request window includes component area 620, seat selection 622, meal selection 624, other requests 626, and request list 628. Component area 620 provides a list of flight components or segments to which the requests will be applied. Seat selection area 622 provides an interface to select a particular seat or type of seat (i.e. a window, aisle, exit row seat etc.). Meal selection area 624 provides an interface to select a particular type of meal (diabetic, vegetarian, kosher, child etc.). Other request area 626 provides an interface to make other special requests, such as specifying a pet will be travelling with the traveler, or that the traveler has large luggage, or golf clubs. A list of currently requested special requests is presented in request list 628.

FIG. 6G is an exemplary window providing a text based seat map according to an embodiment of the invention. The seat map displayed is based on the equipment type for the currently selected flight. A seat can be selected by entering the seat identifier in the seat request box. In an alternative embodiment of the invention, the seat map is displayed in graphical form, with a graphical view representing the interior of the plane and the seating arrangement in that interior. In the alternative embodiment a graphical representation of the seat map is provided. FIG. 6H illustrates an exemplary graphical seat map for a large plane. FIG. 6I illustrates an exemplary graphical seat map for a small plane. In some of the exemplary embodiments, an available seat can be selected by pointing and clicking on the desired seat. In alternative embodiments, seats selections can be entered into edit boxes.

FIG. 6J provides an interface for inputting a compare fare for the selected flight. The compare fare overrides any system selected compare fare and can be used when a compare fare must be manually entered into the system.

An exemplary flight schedule window according to an embodiment of the invention is illustrated in FIG. 6K. The exemplary window includes search parameters 629 and schedule summary area 630. The search parameters 629 provide a mechanism to input search parameters used to limit the number of flights displayed in summary area 130 to a reasonable number. The search parameters include the date of the flight, the source airport, the destination airport, and the approximate time the traveler desires to fly. The schedule summary area 630 includes the client, travel service provider and traveler preference indicators, airline, flight numbers, source and destination airports, departure and arrival times, equipment type, number of stops, the days that the flight operates.

Exemplary air detail windows 632, 634, and 636 are illustrated in FIG. 6L. The exemplary air detail windows provide further information regarding flights selected from the schedule summary area 630. Window 632 provides general information, i.e. the airline name, the departure city, and the arrival city. Window 634 provides details regarding a particular departure or arrival airport, including the name, city code, address, geographic location, and directions to the airport. Window 636 provides information regarding the contract that is applied to the selected flight and fare. Alternative embodiments of the invention provide other categories of air details. These other categories include equipment information, flight information, journey time/stop locations, mileage information, minimum connection time, and vendor messages.

FIG. 6M illustrates a tariff window according to an embodiment of the invention. The exemplary tariff window includes search parameters 638, and tariff summary list 640. Search parameters include the date, departure airport, arrival airport, airline, fare type, and whether flights with fare restrictions, change penalties and advance purchase requirements should be included in the list. Tariffs for flights matching the search criteria are displayed summary list 640. In one embodiment of the invention, the tariff information includes client, travel service provider, and traveler preference indicators, fare basis codes, class of service code, airline, one-way/round trip indicator, round trip fare, advance purchase days, minimum/maximum stays, tariff effective date, tariff expiration date, first travel date (FTD), and last travel date (LTD).

An exemplary recap wrap-up window 642 according to an embodiment of the invention is illustrated in FIG. 6N. The recap window provides a summary of the currently selected flights for the travel order. In one embodiment of the invention, the summary converts code values to text values, for example, three letter airport codes are expanded into the full airport name.

An exemplary payment wrap-up window according to an embodiment of the invention is illustrated in FIG. 6O. The payment wrap-up window includes stored fare area 650, ticket type area 654, and first payment method 651 and second payment method 652. Stored fare area 650 presents the list of currently stored fares for the current travel order. Ticket type area 654 provides a mechanism for specifying whether or not an electronic ticket is desired, and whether an old ticket will be exchanged for the current ticket. In some embodiments, payment for a fare may be split between two or more payment methods. First payment method area 651 provides a mechanism to input the first (and primary) method used to pay for the ticket, which will typically be a credit card. Second payment method area 652 provides a mechanism to input a second payment method if the fare is to be split among more than one payment methods. The options for each credit card information element in payment method areas 651 and 652 are displayed using the traveler's profile data. It should be noted that payment methods are not limited to credit card payments. Invoices, purchase orders, and exchange of unexpired tickets are additional payments methods within the scope of the invention. The invention is not limited to any particular payment method.

An exemplary ticketing wrap-up window is displayed in FIG. 6P. The exemplary window includes ticketing information area 656, and delivery area 658. Ticketing information area 656 includes the last day to ticket (i.e. the last day that the selected tariff will be valid), the date the ticket must be received by the traveler, the date the ticket is to be issued, where the ticket will be printed, and any inserts (i.e. additional information) that is to accompany the ticket. Ticket delivery area specifies information related to the delivery of the ticket to the client, including the delivery method (i.e. same day, next day, two-day, first class mail etc.), the courier to be used, and the address and telephone number of the recipient. The system limits the choices for delivery method to those that can be accomplished by the receive by date, and limits couriers to those that can use the specified delivery method.

FIG. 6Q illustrates an ticket wrapup window according to an alternative embodiment of the invention. The exemplary wrapup window includes pricing option area 614 listing details regarding the currently selected flights, vendor message area 611, override area 618, and component grouping area 613. Override area 618 provides a mechanism for inputting information that causes the fare data to be overridden. Examples of such information include special tour or package designators, or a contract designator that is used to indicate that the client or travel service provider receives a special fare as part of the contract between the parties.

FIG. 6R illustrates an exemplary ticket copy window indicate where a copy of the ticket should be delivered. The information presented and received in FIG. 6R is similar to that discussed above in reference to FIG. 6Q. Delivery address 664 indicates where the ticket copy is to be delivered, and delivery contact 665 indicates a phone number and phone type (Fax, mobile, voice etc.) for a person to be contacted regarding the ticket copy.

FIGS. 6S and 6T provide exemplary emulator windows. The emulator windows provide a direct interface into a GDS, and can be used by a ticket processor or travel counselor to perform tasks that are outside of the scope of the tasks that can be performed using the interfaces described herein. In some embodiments of the invention, the commands that can be issued using the emulator window are limited to those commands that do not allow the user to switch to a different reservation.

An itinerary remarks window according to an embodiment of the invention is illustrated in FIG. 6U. The remarks window includes travel component area 676, remarks option area 674, remarks summary area 678, and exemplary remarks fill-ins 680 and 682. Travel component area 676 provides a list of current travel components, including flight segments for the current travel order. The user selects one of the listed travel components to apply remarks to. The remarks that can be applied are listed in remarks option area 674. Selection of one or more of the remarks causes the selected remarks to appear in the remarks summary list 678. In addition, remarks having further options can be either filled in from a list of further options as illustrated in window 682, or they can comprise free form text that is entered as illustrated in window 680.

A service fee wrapup window is illustrated in FIG. 6V. The service fee wrapup window includes service fee field 690. Field 690 provides a mechanism for a travel counselor to add a service fee to a selected fare. The service fee can be for a variety of reasons. For example, the service fee may be charged to recoup costs due to low or inadequate commissions received from a travel service vendor. Examples of such service fees include fees for booking hotels and/or cars without booking airfare, fees for international travel services, or fees for domestic travel services. The invention is not limited to any particular service fee type.

An exemplary itinerary copy window 6W according to an embodiment of the invention is illustrated in FIG. 6W. The exemplary window includes a delivery method area 694 and a delivery address area 692. The delivery method specifies how the copy is to be delivered. Examples of delivery methods include e-mail, facsimile, postal mail, express mail etc. Delivery address area 692 provide supporting details used to specify the address for the delivery.

Car Rental Components

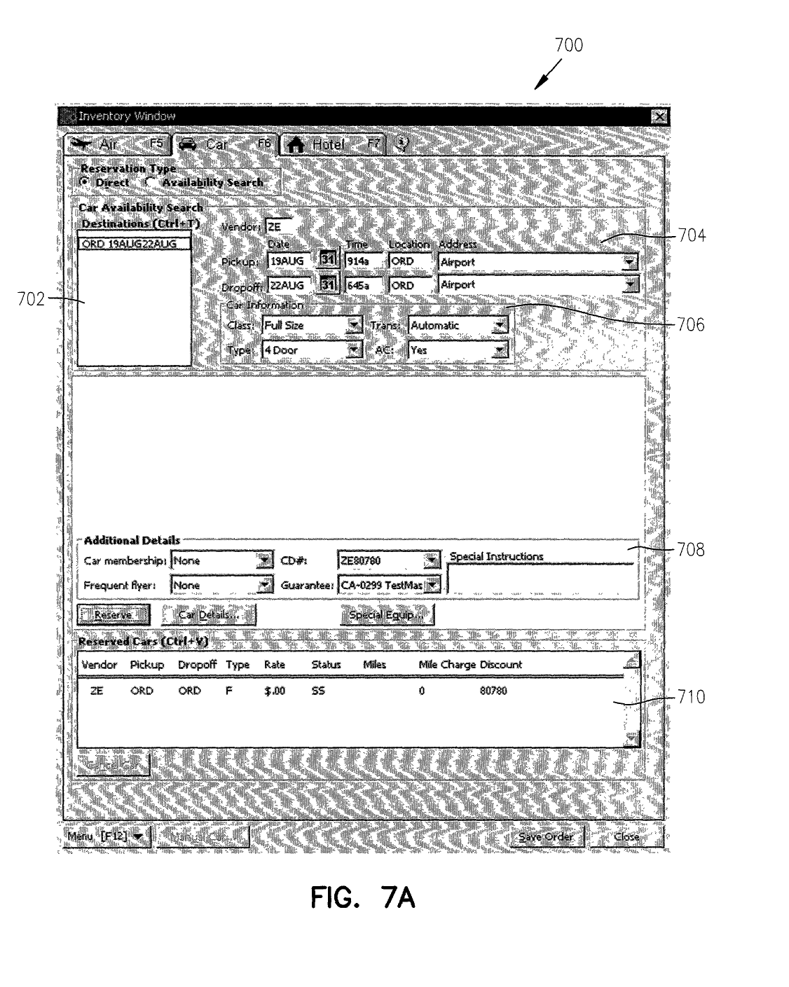

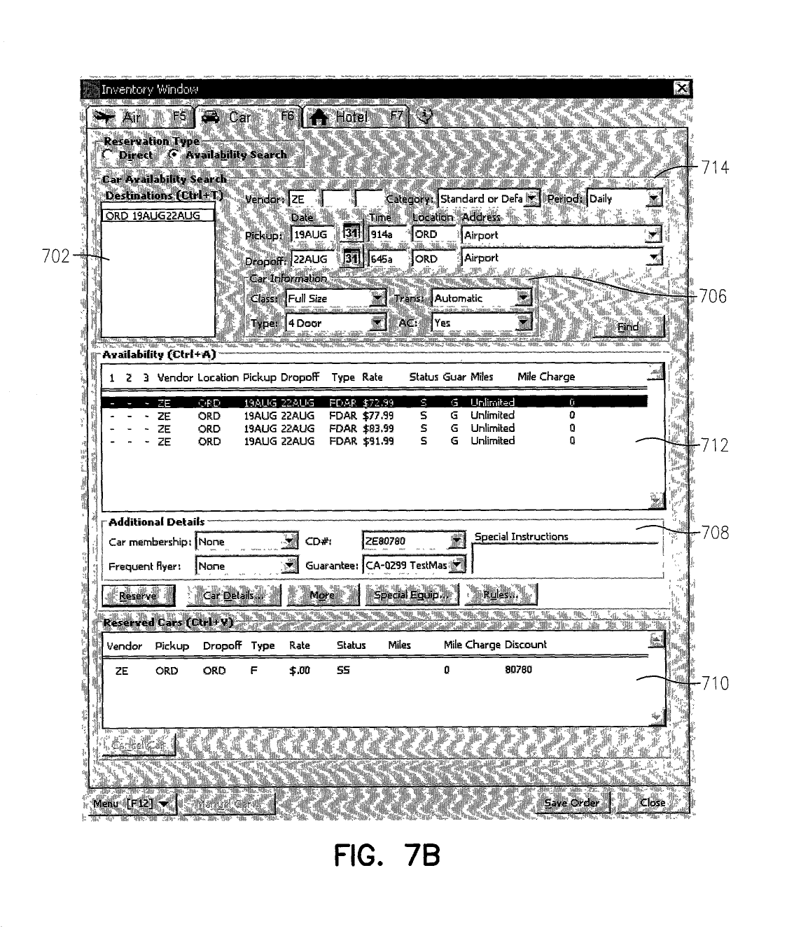

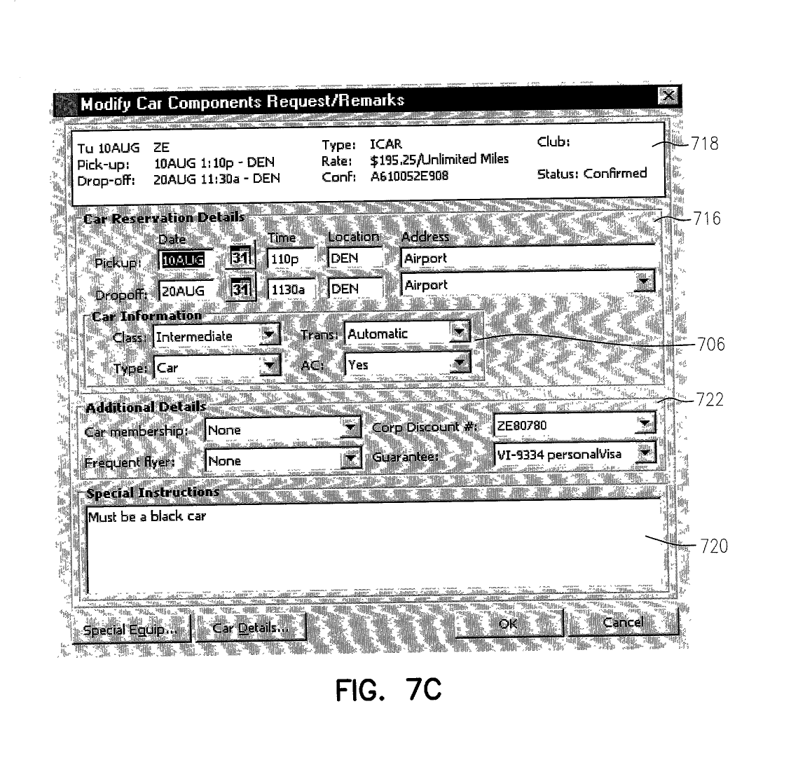

This section of the specification provides a description of systems, methods and interfaces for users such as travel counselors to make car rental reservations on behalf of the client's travelers. An exemplary direct sell car inventory window 700 is illustrated in FIG. 7A. As is known in the art, a direct sell occurs when the service purchaser merely wants a car of a particular type from a particular vendor, and is not interested in search among a number of different vendors and types of cars for a particular rate, model etc. The exemplary window 700 includes search parameters area 704, details area 708, and reservation list 710. Search parameters area 704 provides a mechanism for supplying parameters describing the desired type of car. Destination area 702 of search parameters 704 specifies the destination where the car will be picked up. In one embodiment of the invention, the destination, date, and location search parameters can be filled in with default values obtained from the values input for the air travel components of the travel order. Car information area 706 includes car class, car type, car transmission, and air conditioning search parameters. These values, in addition to the vendor value, can be defaulted to values obtained from the current traveler's profile.

Additional details area 708 provides a mechanism for providing further information, such as loyalty program membership numbers, corporate discount identifiers, frequent flyer membership numbers, and rate guarantee information. The values can be defaulted to values obtained from client information if appropriate, or from the traveler's profile.

A car meeting the search criteria is displayed in reserved car area 710. In one embodiment of the invention, the pickup and drop-off locations, car type, rental rate, reservation status, number of free miles, charge per excess miles, and corporate discount are displayed.

FIG. 7B illustrates an exemplary car inventory availability search window. An inventory availability search is performed when the traveler wishes to be informed of available car rental choices. The inventory availability window includes search parameters 714, availability area 712, additional details 708, and reserved car area 710. Search parameters 714 are similar to search parameters 704, with the addition of multiple vendors, car category, and rental rate period search parameters.

A list of cars meeting the search criteria is displayed in availability area 712. In one embodiment of the invention, the details displayed for each car include the following:

| | |
|---|---|
| 1 - | An indicator whether the client company prefers the car |
| | vendor, perhaps due to a contract between the car vendor |
| | and the client company giving preferred rates to the client. |
| 2 - | An indicator whether the travel service provider prefers the |
| | car vendor due to the existence of a contract between the |
| | travel service provider and the car vendor. |
| 3 - | An indicator whether the traveler prefers the car vendor, |
| | as read from the travelers profile data described above. |
| Vendor | Vendor code identifying a car rental service |
| Pickup | Car pickup location |
| Drop-off | Car drop-off location |
| Type | Type of car |
| Status | Reservation Status supplied by GDS |
| Guar | Indicator of whether rate and availability have been |
| | guaranteed with a credit card |
| Miles | Number of free miles included in rental |
| Mile Charge | Charge for each mile in excess of free miles |

After a car reservation has been made, it sometimes must be modified. An exemplary reservation modification window is illustrated in FIG. 7C. The exemplary window includes current (i.e. pre-modified) car reservation data 718, reservation details area 716, car information area 706, additional details area 722, and special instructions area 720. Reservation details 716 includes the pickup and drop-off location, and the date and time of the rental. Additional details window 722 includes loyalty program membership numbers, corporate discount numbers, and a credit card identifier used to guarantee the availability of the car. The information in the above-described areas can be modified and the modified information forwarded to a car rental GDS for update.

Hotel Component

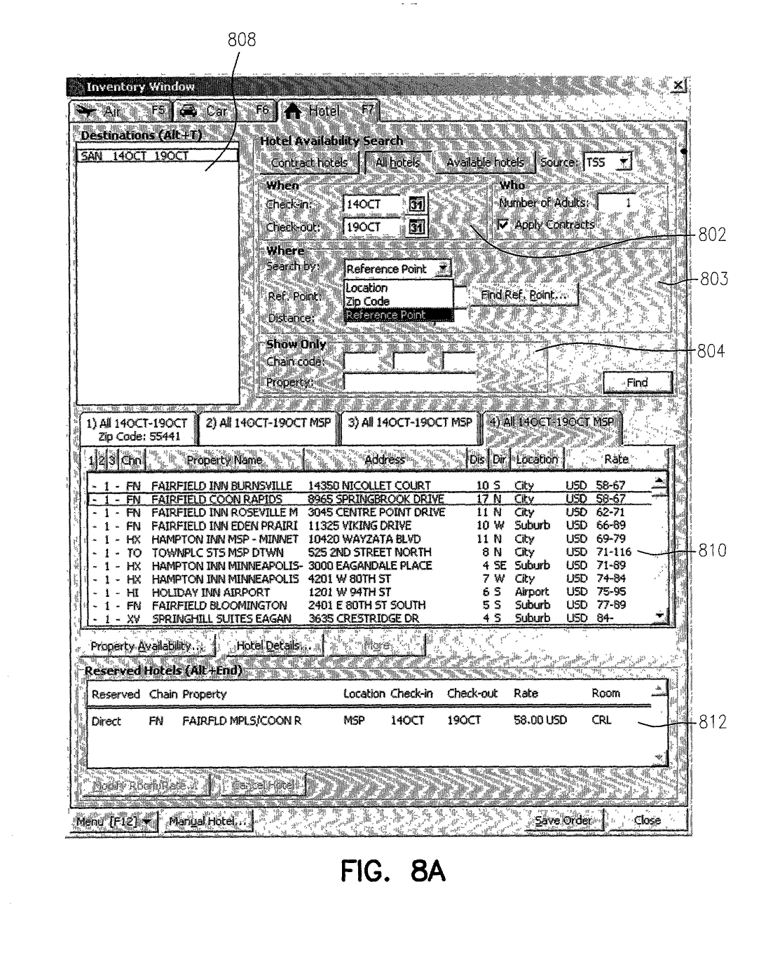

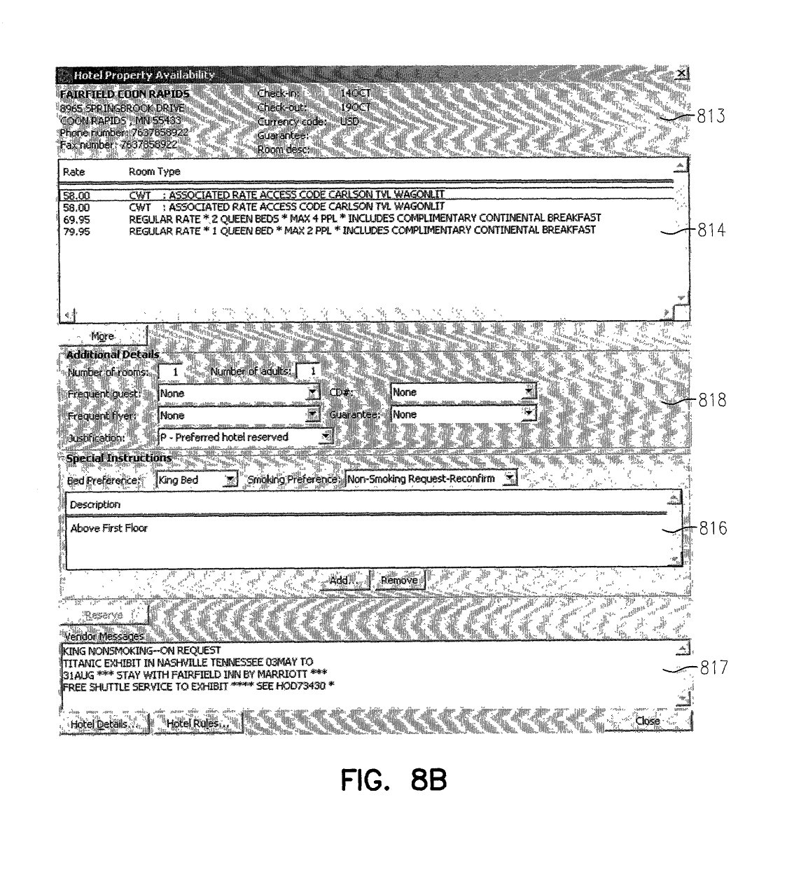

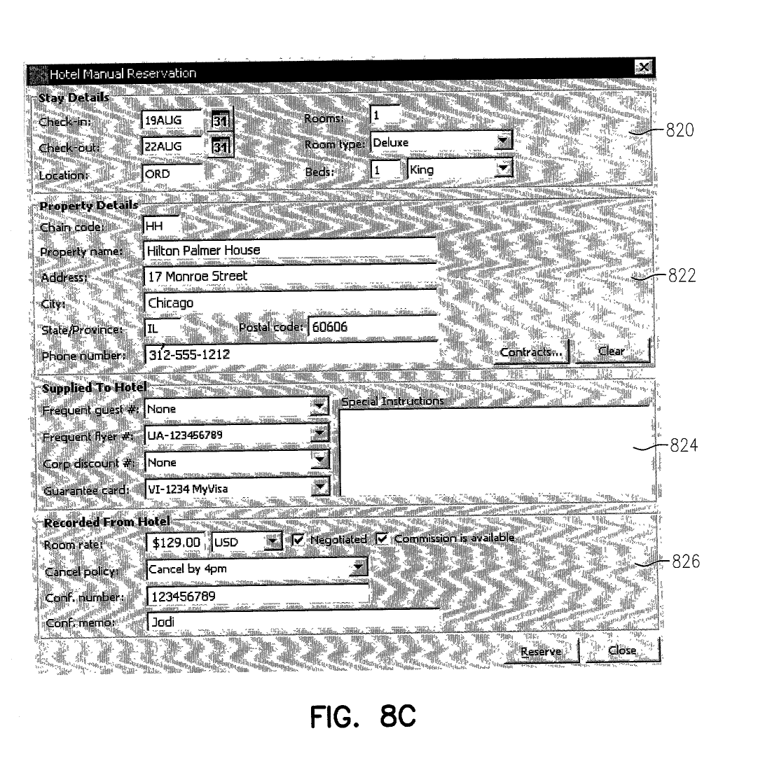

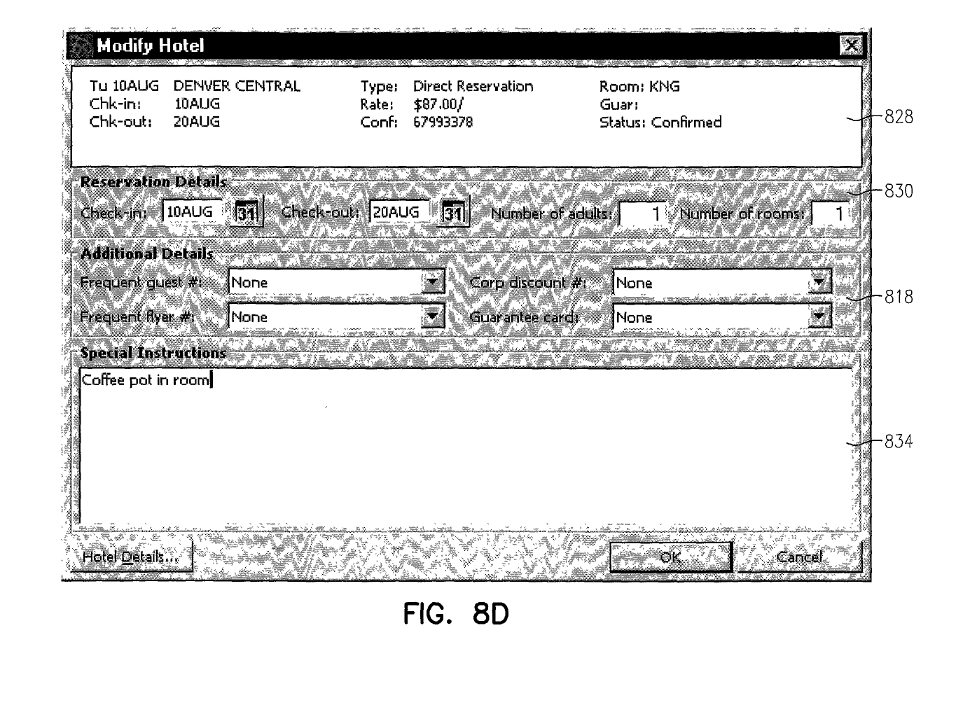

This section of the detailed description describes systems, methods, and interfaces for reserving hotel rooms. FIG. 8A is an illustration of an exemplary hotel inventory window according to an embodiment of the invention. The inventory window includes a search parameters area 802, including destination 808, date and location area 802, general options 804 and search type area 803. Destination 808 can be defaulted to the destinations specified in either the air component or car rental component. Date and location information can likewise be defaulted to that provided in the other reservation components. General options 804 provide additional parameters such as hotel chain codes or particular properties. Search area 803 indicates the area where the search is to be performed. In one embodiment of the invention, the search area can search by location, by zip code, or by a reference point. In addition, a maximum distance from the selected type can be input. In some embodiments, the search can be for all hotels that match the supplied search parameters, or it can be limited to only those hotels that have rooms available, or those hotels that have rooms available and that have a preferred rate contract with the client or travel service provider.

Search results area 810 provides a list of hotels that match the input search parameters. A user, such as a travel counselor, can select one or more of the properties and reserve a room. Upon selection and reservation, the selected hotel appears in the reserved hotel list 812.

An exemplary hotel property availability window 813 is illustrated in FIG. 8B. The availability window can be displayed by the system when a hotel is selected from search results window 810. The window includes room rate list 814, vendor message area 817, details area 818, and special instructions area 816. Rate list 814 provides a list of room types available at the hotel for the selected date, and the rates for the room. Additional details area 818 provides a mechanism to provide the number of rooms requested, the number of adults occupying the room, and loyalty program membership numbers. In addition details area 818 provides justification field that allows a user to input a justification code when a travel policy is overridden. Special instructions area 816 can be used to make special requests, such as non-smoking room. Vendor message area 817 provides a display of vendor specific information such as rules or promotions that apply to a selected hotel rate, or special services provided by the hotel.

Occasionally it is necessary to make manual reservations, i.e. via a phone call to the property, for a hotel. As an example, some hotels are not part of a GDS. However, it is still desirable for the reservation to be recorded within the system. FIG. 8C illustrates an exemplary manual reservation window. The exemplary window includes stay details 820, property details 822, supplied information area 824, and received information area 826. Stay details 820 include the check-in and check-out dates, room type, location and number and type of beds required. Property details 822 include details on the property, such as the chain code, the property name, the address, and phone number of the property. Information supplied to the hotel 824 provides a mechanism to record information provided by the travel counselor to the hotel, such as loyalty program information, corporate discount numbers, and an identifier of the credit card used to guarantee the room. Received information 826 provides a mechanism to record information received from the hotel, such as the room rate, the cancel policy, the confirmation number, and a confirmation memo that can be filled in with confirmation details, such as the name of the person at the hotel providing the rate information.

FIG. 8D provides an exemplary hotel reservation modification window. The exemplary window includes current details 828, reservation details 830, additional details 818, and special instructions 830. Current details 828 displays the current (i.e. unmodified) reservation data. Reservation details 830 provides a mechanism for modifying the check-in, check-out dates, number of rooms, and number of adults occupying the room. Special instructions 834 provides a mechanism for updating or adding any special instructions related to the reservation. The update information can then be forwarded to the GDS maintaining the hotel reservation.

Limousine Component

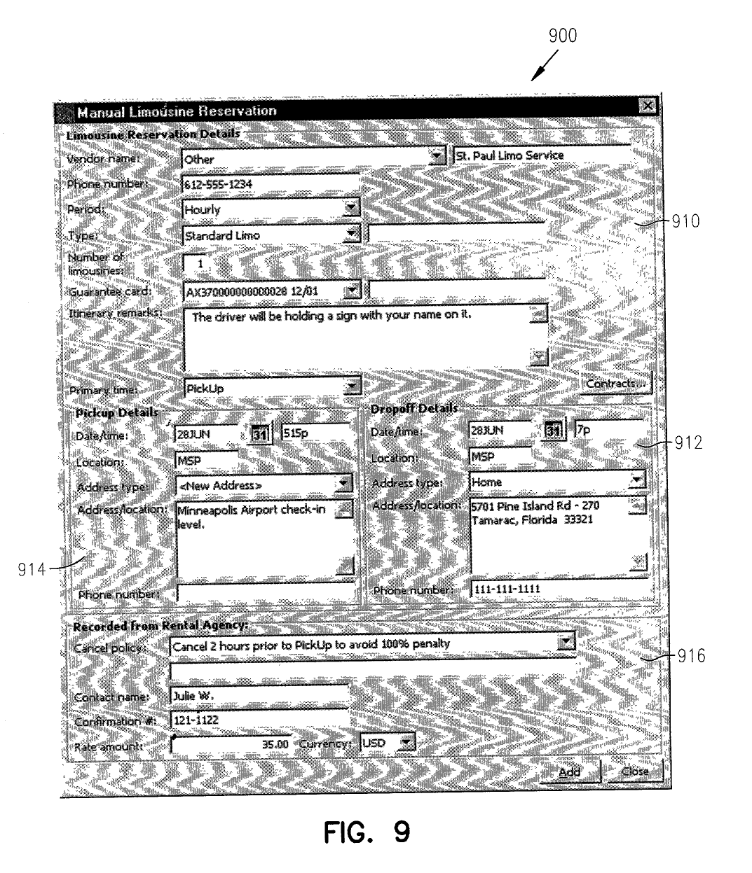

This section of the detailed description describes a limousine reservation component. FIG. 9 illustrates an exemplary limousine reservation window 900 according to an embodiment of the invention. In the exemplary embodiment, window 900 includes reservation details area 910, pickup detail area 914, dropoff detail area 912 and agency information area 916.

As shown in FIG. 9, reservation details area 910 includes information such as the vendor name providing the service, and the vendor's phone number. The “Primary Time” field which indicates if it is more important to be picked up at a certain time or to be dropped off at a certain time. The “Period” can be Daily, Half Day, Hourly, or Transfer. The “Type” can be Bus, Standard Limo, Sedan, Stretch, Van, or Other, meaning that a user can fill in the blank. The Guarantee Card is defaulted from a list of cards that the traveler has in their profile or can be “direct bill” if the client allows it. A new credit card can be entered as well.

Pickup detail area 914 specifies the date, location, address, and phone contact information related to where the limousine should pick the traveler up. Dropoff details area 912 specifies the date, location, address, and phone contact information related to where the limousine should drop the traveler off.

Agency information area 916 provides information received from a representative of the limousine rental agency regarding the cancellation policy, the name of the representative, and a confirmation number for the rental. Also included is rate information regarding the rental.

Utility Components

The system includes a number of components that can be referred to as utility components. These components include a travel order copy component, and conversion/information components.

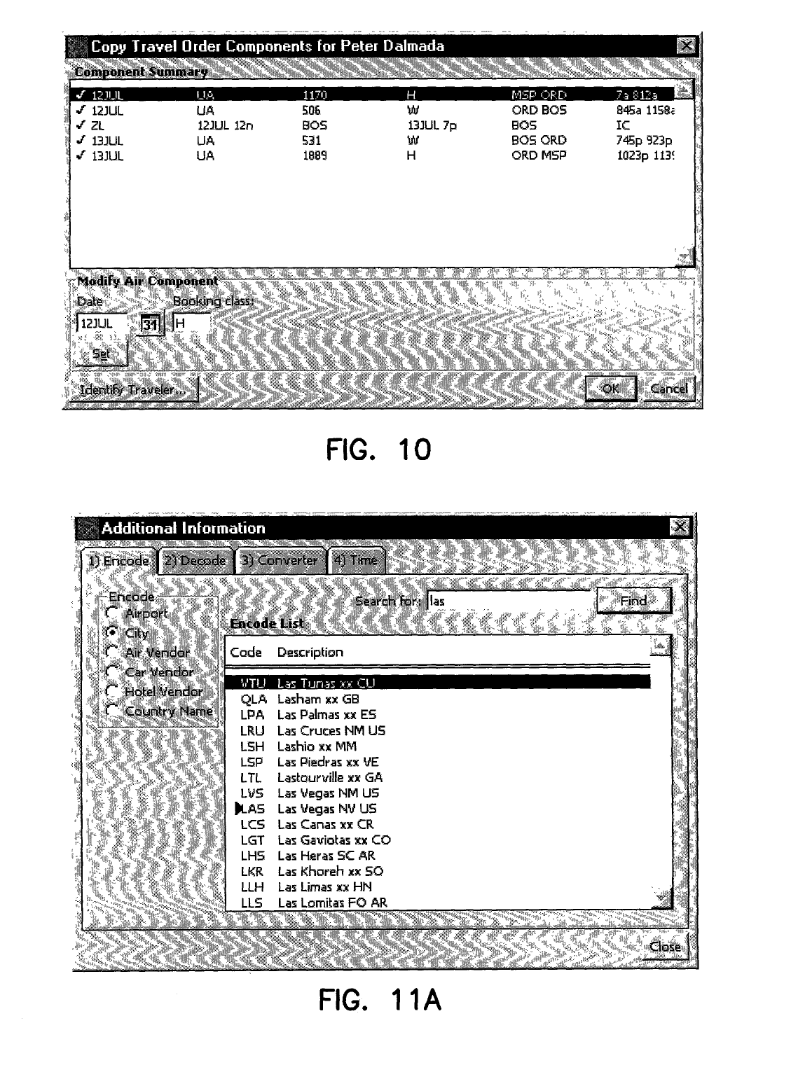

FIG. 10 illustrates a travel order copy component according to an embodiment of the invention. The travel order copy component provides a mechanism for copying all or portions of a previously entered travel order. A previously existing travel component is retrieved from the system database and displayed to the travel counselor. The travel counselor can then select the travel components to include in the new travel order. Certain elements of the travel component can be modified as appropriate, for example, the travel date and booking class can be modified for a selected travel component. It is desirable to provide a copy component, because it allows a travel counselor to easily fulfill new travel orders that are similar to previously existing travel orders. For example, recurring business trips can be easily booked. Additionally, travel orders for multiple travelers traveling at the same time can be easily entered into the system by establishing one travel order for a traveler in the group and copying it to the other travelers in the group. Also, if a first traveler recommends a particular flight or hotel to a companion, the companion can ask for the same flight or hotel simply by asking the travel counselor to book the same flight or hotel used by the first traveler.

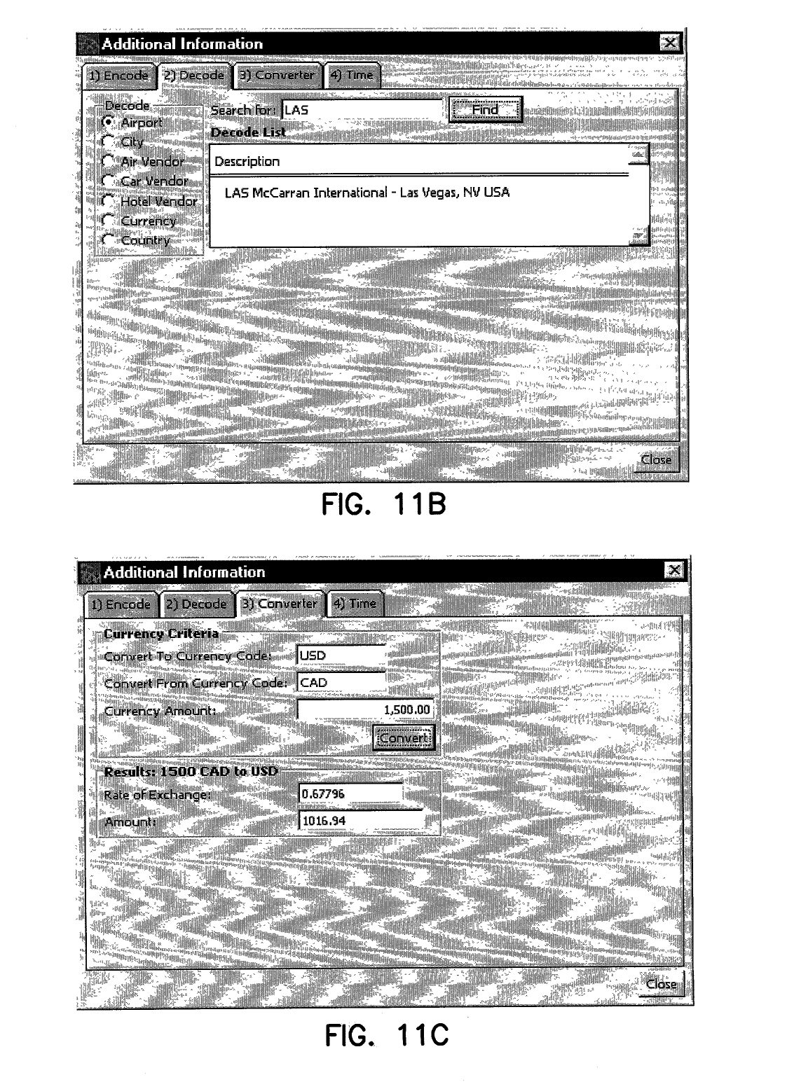

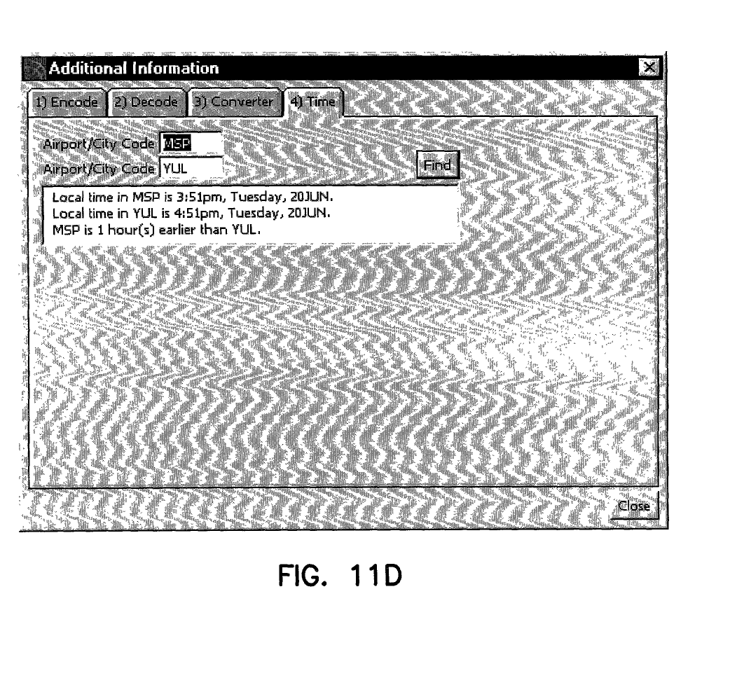

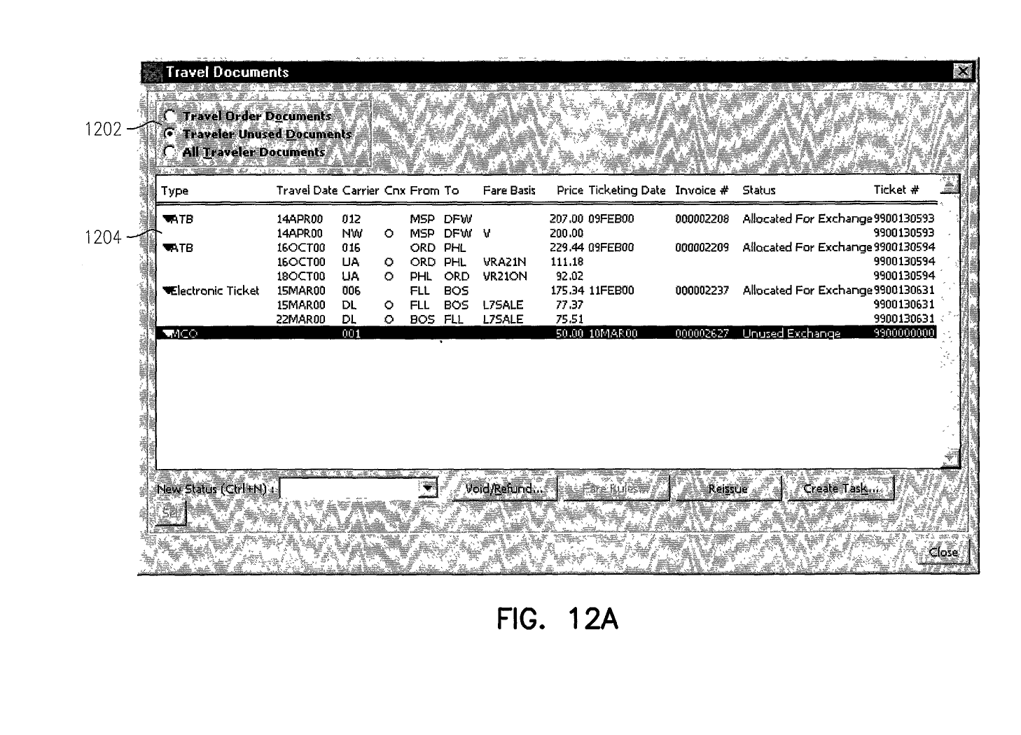

FIGS. 11A-11D illustrates additional information windows that can be obtained from the system to aid a travel counselor. FIG. 11A illustrates an exemplary code conversion window according to an embodiment of the invention. The code conversion window provides a mechanism for a travel counselor to search for a code by inputting text describing the entity represented by the code. For example, if the travel counselor wishes to search for a three letter airport code, the counselor can enter text describing the location into the edit box. The system then searches for matches and provides a list codes and their associated text description.

FIG. 11B illustrates an exemplary decode conversion window according to an embodiment of the invention. The decode window provides a mechanism for a user such as a travel counselor to enter a code and receive a text description of the entity represented by the code.

FIG. 11C illustrates an exemplary currency conversion window according to an embodiment of the invention. The currency conversion allows a user to input a “from” currency and a “to” currency, and an amount to be converted. The system displays the exchange rate and the converted amount to the user.

FIG. 11D illustrates a time conversion window according to an embodiment of the invention. The user inputs two locations and in response the system displays the local time in the two locations and the time difference between the two locations.

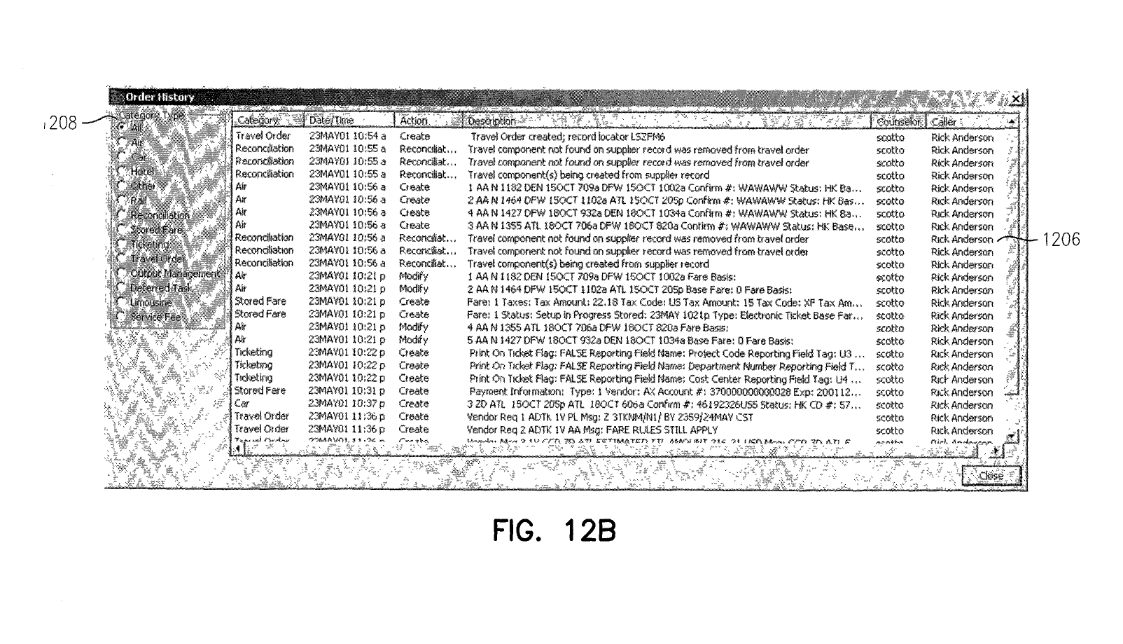

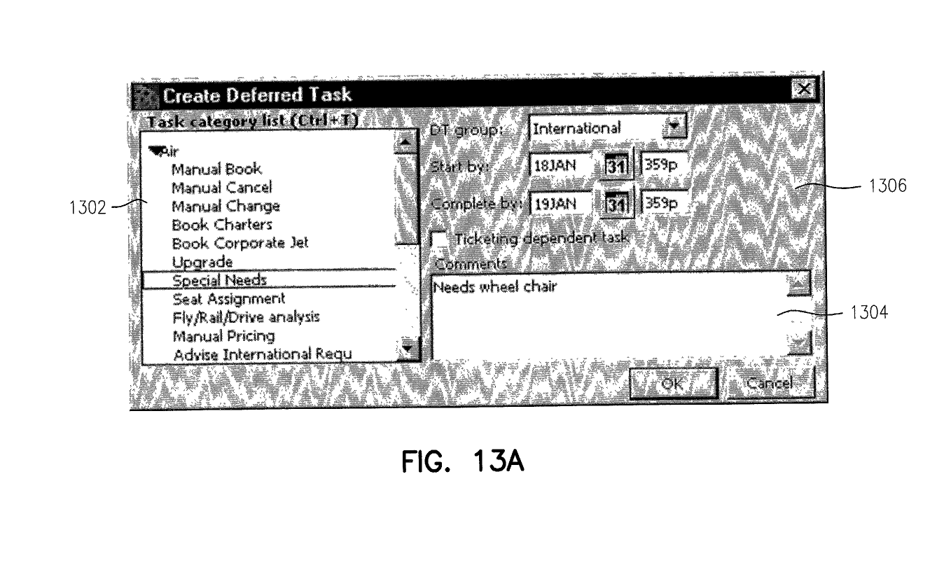

FIG. 12A illustrates an exemplary travel document window according to an embodiment of the invention. The travel document window includes a filter area 1202 and a document list 1204. Filter area 1202 controls what is displayed in document list 1204. The filter can include all travel documents, all documents for a particular travel order, or all currently unused documents. The documents can be selected and actions performed on the selected document. These actions include obtaining a refund for an unused document, applying the value of the unused document to other travel components, or reissuing the travel document.

FIG. 12B illustrates an exemplary travel order history according to an embodiment of the invention. FIG. 12B includes category 1208 and order history field 1206. In one embodiment, category 1208 controls the scope of information displayed in field 1206. The display can display all available history items in the database related to a travel order, or it can be limited to particular types of records. For example, the display can be limited to only air transactions, or car transactions etc. Display area 1206 displays information for each record for a travel order. In one embodiment, the information displayed in area 1206 includes the category, a timestamp, an action code, a description of the record, the person responsible for the entry of the record, and the person who called regarding the record.

Deferred Tasks Component

One aspect of the system is the ability to defer tasks until a later time. It can be necessary to defer tasks for a number of reasons. For example, the traveler may wish to merely provide travel dates to the travel counselor, and not wait on the phone for the counselor to perform all of the required air, car, and hotel reservation tasks. In this case, the tasks can be deferred and the travel counselor can then be free to service other clients. Another reason is that links to the appropriate GDS may not be operational, resulting in the need to perform some tasks at a later time.

Deferred tasks can be presented to travel counselors as they become available. Travel counselor availability can be determined through queries to the call management system 122 (FIG. 1). In addition, tasks can be presented to travel counselors based on skill groups or levels associated with the travel counselor. For example, foreign reservations might be routed to one group of travel counselors, while domestic reservations routed to another group. In some embodiments of the invention, deferred tasks are not presented to travel counselors within a matching skill group until a threshold of counselor availability has been reached. This insures that a sufficient number of counselors are available to answer incoming phone requests.

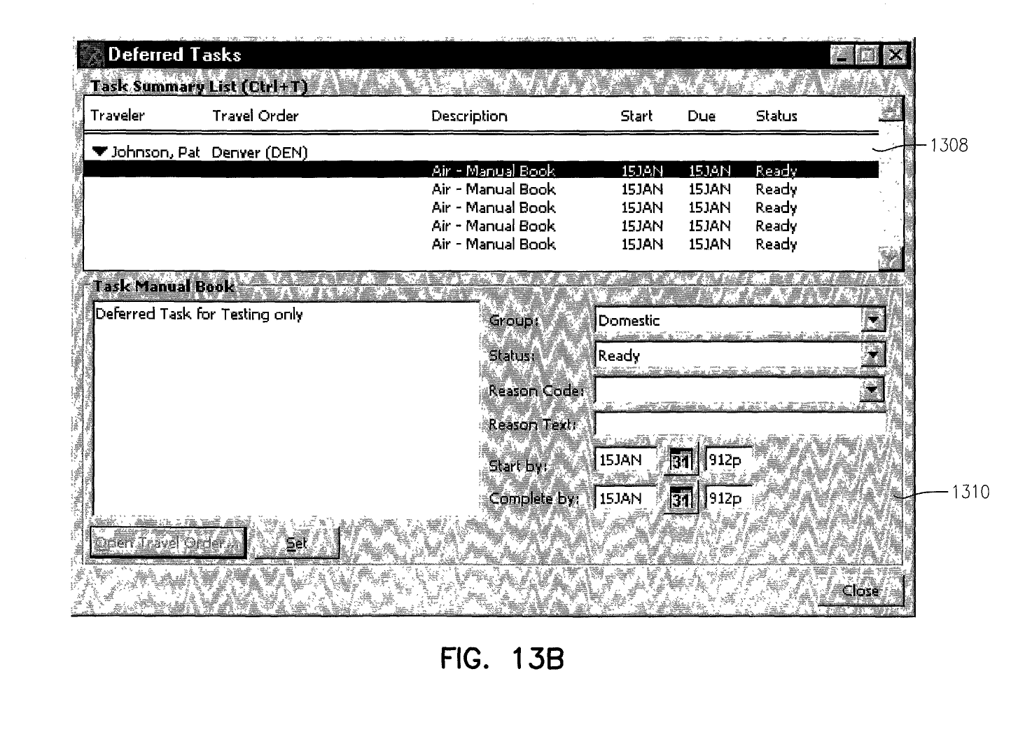

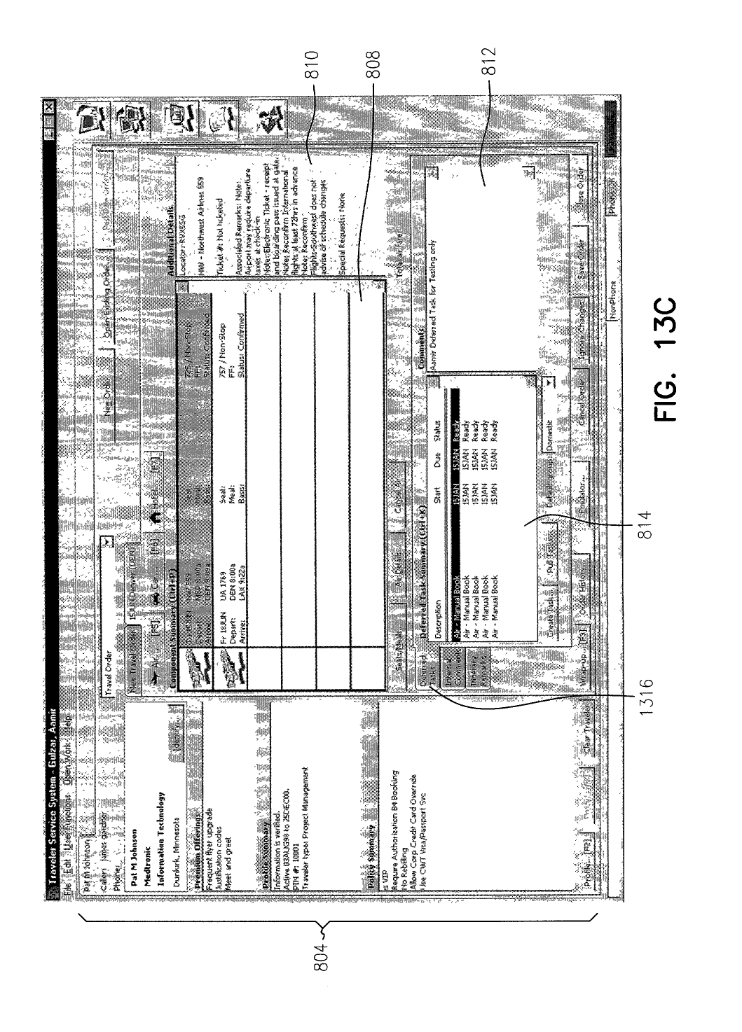

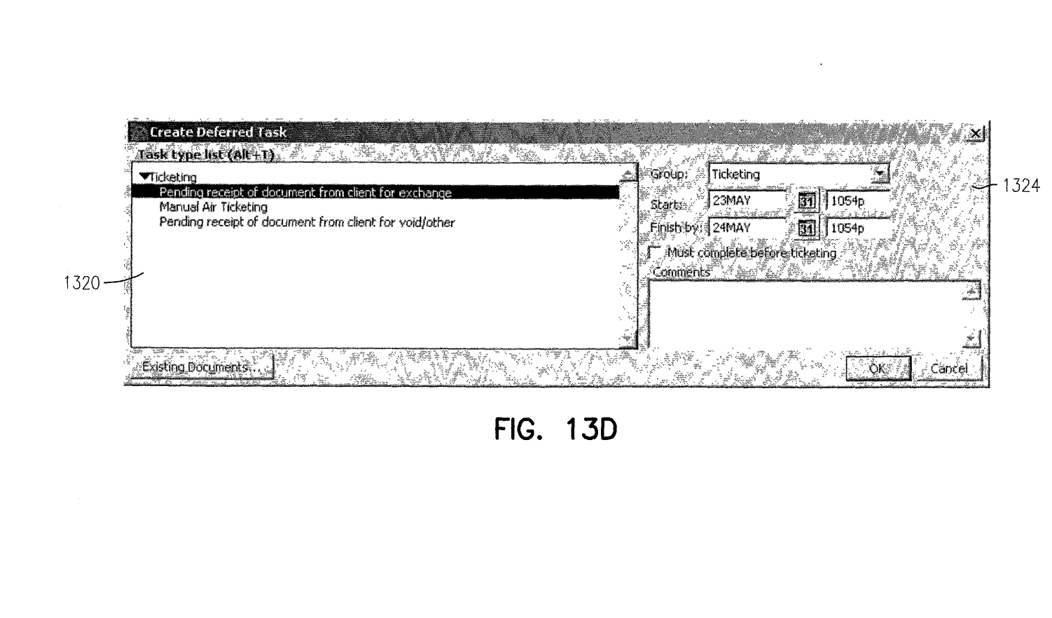

FIG. 13A is an exemplary deferred task creation window according to an embodiment of the invention. The exemplary window includes task category 1302, deferred task details 1306, and comments area 1304. Task category 1302 defines the type of deferred task to be created. The system maintains lists of deferred task types grouped by reservation type (air, car, hotel etc), which can be selected from task category area 1302. Task details 1306 include the date the deferred task must be started by, the date the deferred task must be completed, the deferred task group (for use in routing the task to appropriate counselors), and whether the task is dependent on a ticketing event. Comments area 1304 provides a mechanism for providing a special comments related to the deferred task.

An exemplary deferred task window 1307 according to an embodiment of the invention is presented in FIG. 13B. The deferred task window 1307 includes summary area 1308, and task details area 1310. Summary area 1308 provides a list of the deferred task associated with a currently selected travel service order. Task details area 1310 provides details regarding a particular deferred task selected from the summary area 1308. The details include the deferred task group (for task routing), the current status of the deferred task (ready, in progress, completed, requeued), and the start by and complete by dates for the tasks.

FIG. 13C provides an illustration of the initial window 400 when the deferred tasks tab 1316 has been selected. The initial window is updated to present deferred task summary 1314 and deferred task comments 1312. Deferred task summary 1314 provides a list of the deferred tasks associated with the selected travel service order, and the comments area 1312 presents any comments associated with the currently selected deferred task in summary 1314.

FIG. 13D is an exemplary window that illustrates a particular type of deferred ticketing task. In the exemplary window, task type 1320 includes a list of ticketing related task that are typically deferred. Examples include manual ticketing and task associated with processing documents or tickets that are required to complete the travel order. For example, a traveler may wish to exchange an unused ticket for a new ticket associated with the current travel order. The order cannot typically be completed until the unused ticket is received in the mail. Thus a deferred task is required. Similarly, the traveler may be required to submit other documents such as coupons or other discount offers in order to complete the travel order. Details field 1324 includes information regarding what group is to process the deferred task, when the deferred task can start, and when the deferred task must be completed by.

Customer Service Window

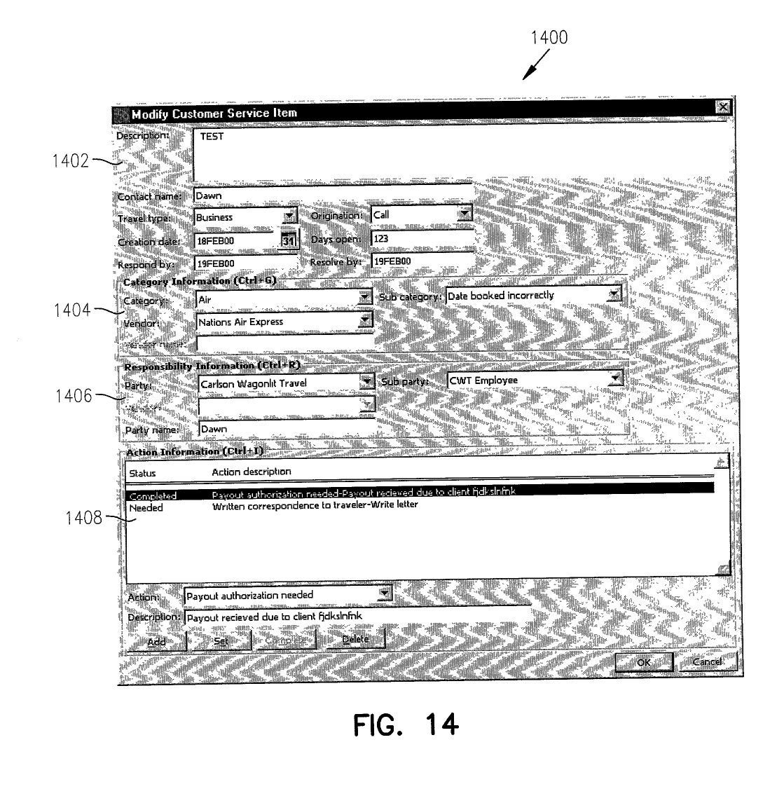

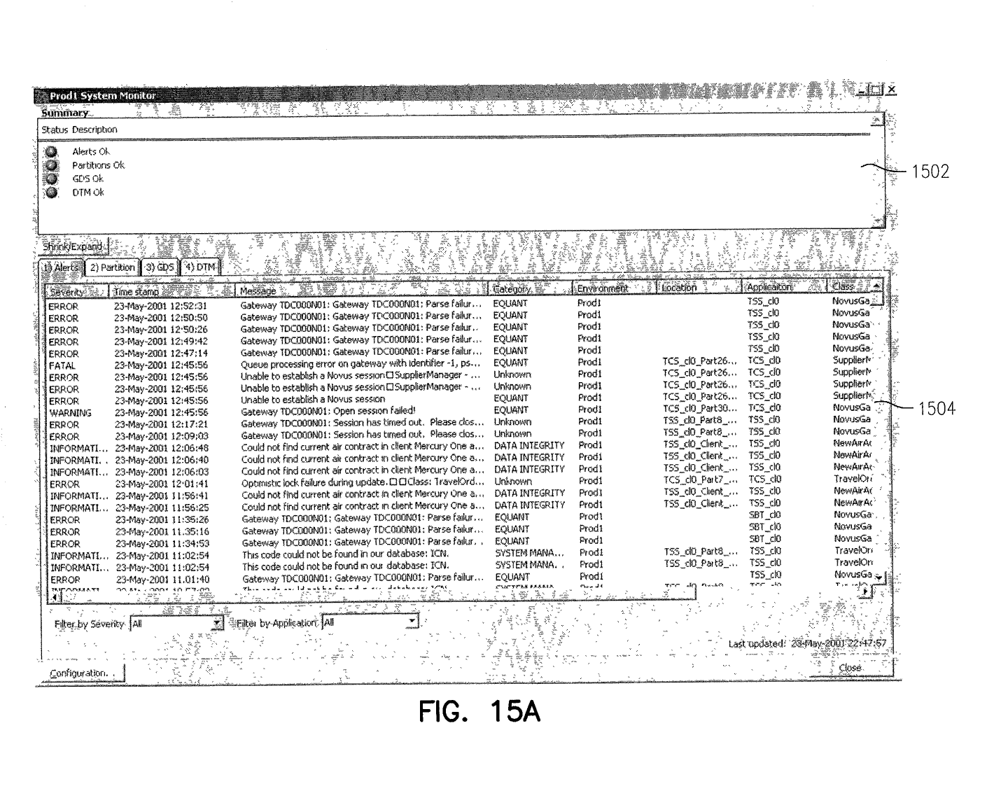

FIG. 14 illustrates an exemplary customer service window according to an embodiment of the invention. The exemplary customer service window 1400 includes description area 1402, category area 1404, responsibility area 1406, and action area 1408. Description area 1402 provides mechanism to input and display data such as a text description of a service item (i.e. an issue, problem, or activity), the person initiating the service item, the travel type related to the service item, the time the item was created, when a response is due, when the item must be resolved, and how long the item has been outstanding (i.e. unresolved).

Category information 1404 provides category information regarding the item such as the type of travel component (air, car, hotel etc.), the vendor providing the component, and a general indication of the subject matter of the item.

Responsibility area 1406 provides information regarding who is responsible for resolving the item, including the party name, party, and sub-party responsible.

Action information area 1408 provides a list of actions required to resolve the item, and the current status of each action. Actions can be selected from a drop down box, and a description of the action can be entered into an edit box causing the action to be added to the action list.

Maintenance/Monitor Components

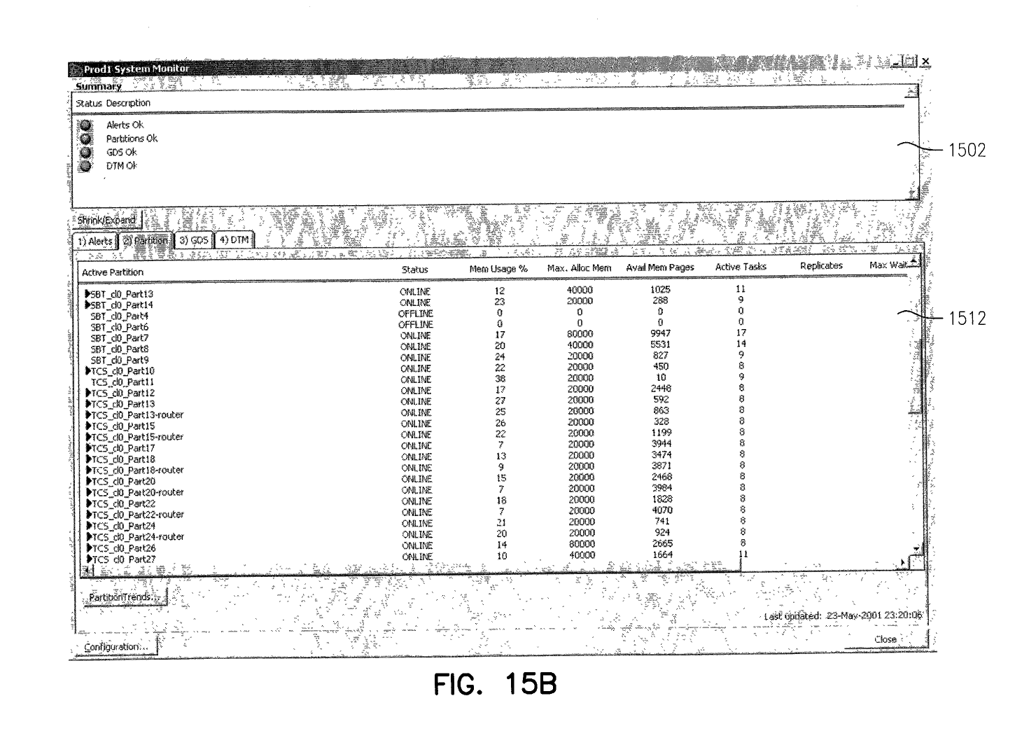

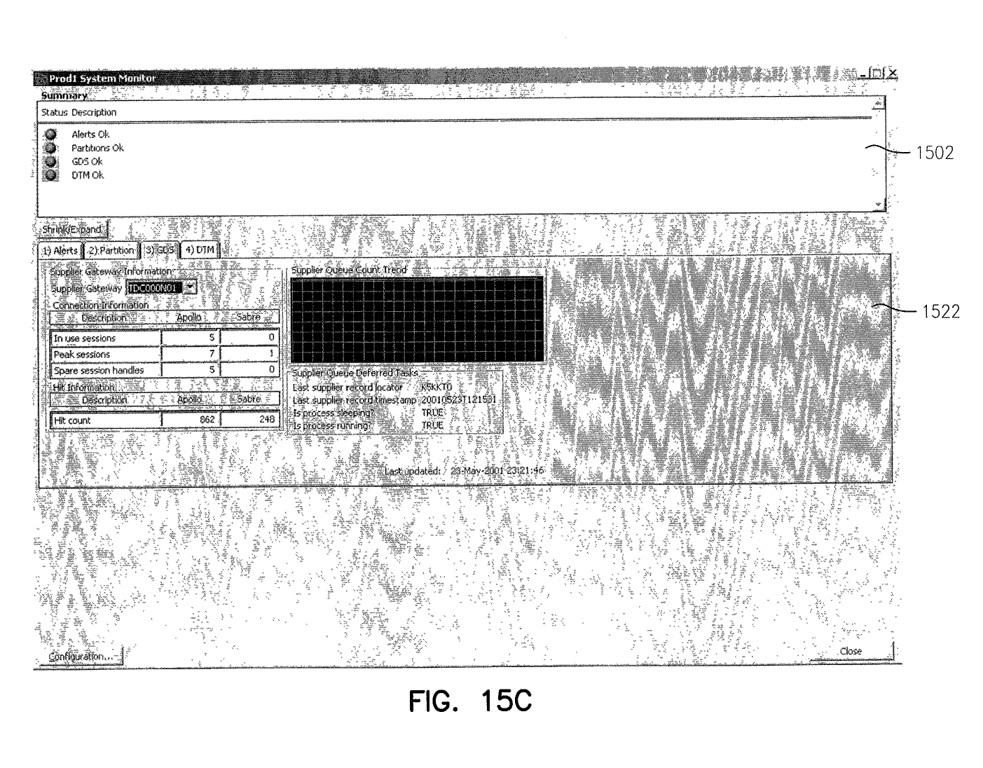

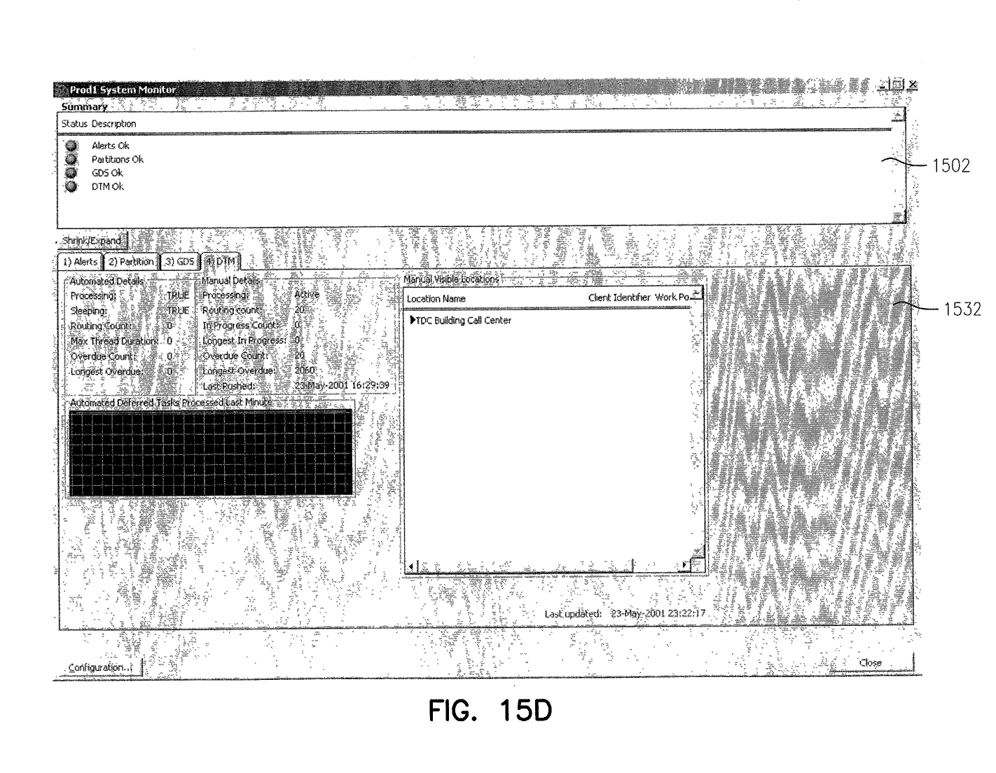

Some embodiments of the invention include maintenance and monitor components. FIGS. 15A-15D illustrate exemplary windows that provide monitoring functions for system alerts, partition parameters, GDS session parameters, and deferred task parameters. In some embodiments, each of windows 15A-15D includes a status summary field 1502. The status summary field indicates an overall status for each of the monitored functions. Should one of the monitored functions exhibit anomalous behavior, a user can quickly go to the appropriate detail screen to obtain more information.

FIG. 15A illustrates an exemplary alert window according to an embodiment of the invention. The exemplary alert window additionally includes alert table 1504. Alert table 1504 includes a record for each alert generated by the system. Typically an alert is generated upon detection of an error condition. In one embodiment, an alert record comprises a severity, a timestamp, a detail message, an alert category, the environment that generated the alert, the location of the alert, the application that generated the alert, and the class of the alert. Other alert fields are possible and within the scope of the invention.

FIG. 15B illustrates an exemplary partition parameter window according to an embodiment of the invention. Exemplary partition parameter window additionally includes partition table 1512, which displays information about partitions known to the system. In one embodiment, partition table 1512 includes parameters for the partition name, the partition status, percentage of memory used in the partition, the amount of memory allocated to the partition, number of pages of memory available to the partition, number of active tasks in the partition and replication data regarding the partition. As those of skill in the art will appreciate, other partition data could be included and is within the scope of the invention.

FIG. 15C illustrates an exemplary GDS session parameters window according to an embodiment of the invention. In some embodiments of the invention, upon startup of the system the software reads configuration parameters to determine the size of the supplier session pool. The system then pre-opens and signs in the set number of supplier connections and puts them in a pool. Users of the core services that request access to a supplier system thus have faster access and better response time. The exemplary GDS session parameter window includes session display 1522 that displays information regarding the use of the pooled sessions. In one embodiment, the information includes current and peak usage, and spare sessions available for use.

FIG. 15D illustrates an exemplary deferred task management (DTM) window according to an embodiment of the invention. DTM details area 1532 includes information regarding automated deferred tasks and manual deferred tasks, and a list of locations for processing manual deferred tasks.

In some embodiments of the invention, the system includes an application that runs each night and checks all non-traveled reservations for a lower fare on the same flight in the class of service that was booked. The system can then notify the travel counselor or the traveler to inform them of the lower fare. In alternative embodiments of the invention, the lower fare is automatically booked by the system. In further alternative embodiments, a deferred task can be created to cause the lower fare to be booked upon review by a travel counselor.

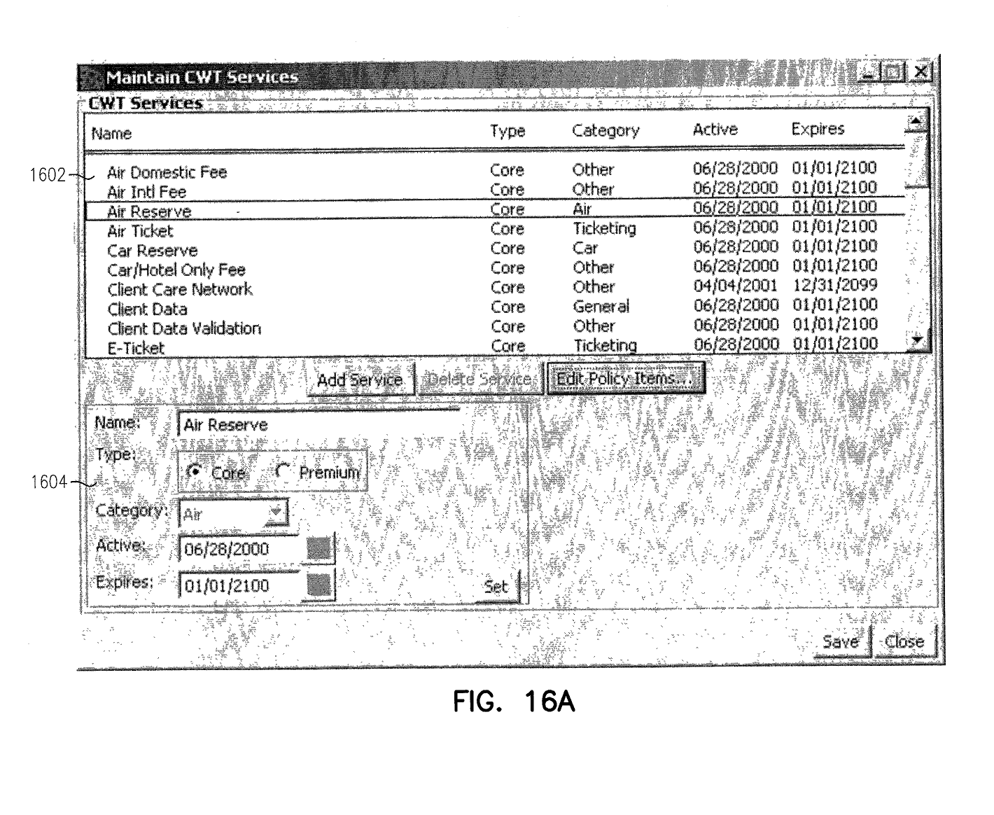

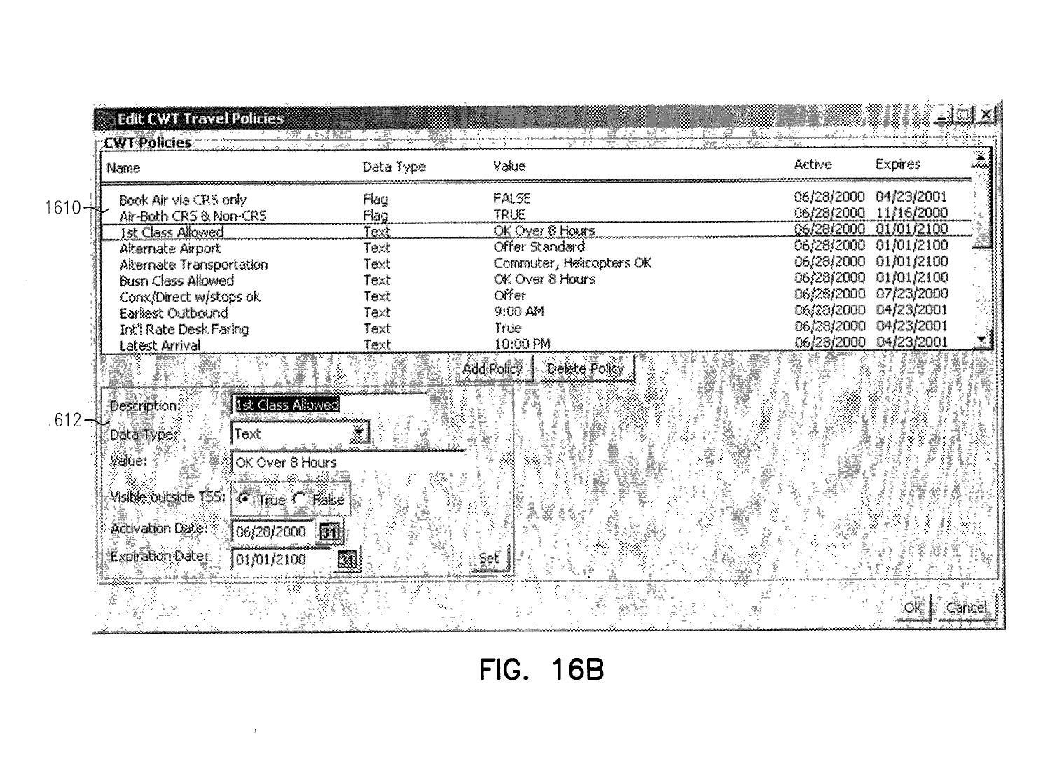

FIG. 16A illustrates an exemplary service maintenance window according to an embodiment of the invention. The exemplary window includes service table 1602 and service edit area 1604. Service table 1602 is a list of available services that can be provided by a travel counselor/user of the system. Examples of services include booking domestic and international fares, car rental reservations, hotel reservations, managing client data etc. Fees can be associated with services, and services can have beginning and end dates for which the service is valid. Additionally, services can be packaged together as a unit and supplied on a fee basis or a non-fee basis. Service edit area 1604 provides a mechanism to maintain data in service table 1602. Details regarding a service appear in edit area 1602 upon selection of a service in table 1602.

FIG. 16B provides an illustration of an exemplary travel policy maintenance window. In one embodiment, travel policy maintenance window includes policy table 1610 and policy edit area 1612. Policy table lists the policies that can be applied to travel orders requested by a traveler. As noted above, travel policies are typically specified by a client corporation and apply to travel requested by employees or other persons associated with the client corporation. Examples of such policies include whether or not first class or business class travel is allowed, whether alternate airports and travel methods are allowed, whether connections must be offered or not etc. Each potentially applicable policy is listed in table 1610. A user can add or edit policy parameters using fields in policy edit area 1612.

Method For Acquiring Travel Related Data

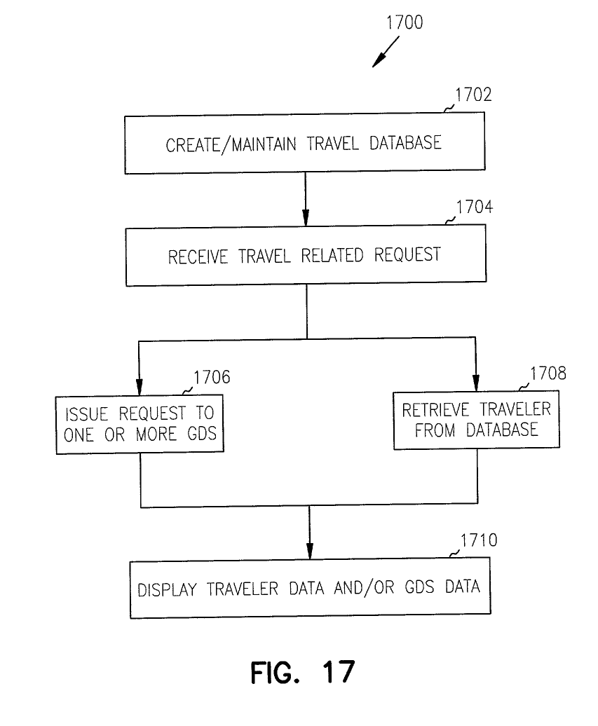

In this section of the detailed description, a method according to an embodiment of the invention is presented. This description is provided in reference to FIG. 17. The computerized method is desirably realized at least in part as one or more programs running on a computer—that is, as a program executed from a computer-readable medium such as a memory by a processor of a computer. The programs are desirably storable on a computer-readable medium such as a floppy disk DVD-ROM or a CD-ROM etc., for distribution and installation and execution on another (suitably equipped) computer. Thus, in one embodiment, a computer program module is executed by a processor of a computer from a medium therefrom acquire and display travel related data.

In one embodiment of the invention, the method begins by creating and maintaining a travel database (block 1702). The database desirably contains data about corporate travel policies and preferences, individual traveler preferences and personal details, time zone conversion details, currency conversion details and other travel related data.

Next, a system executing the method receives a travel related request (block 1704). The request can be air, car, hotel, limousine, or train travel related. The system then uses data received in the request to perform searches of the travel database (block 1706) and searches of one ore more GDS systems (block 1708). As is indicated by the parallel placement of the blocks, it is not significant to the invention what order the requests take place. However, in some embodiments, the travel database is searched first in order to obtain information that can be used to refine the request issued to the one or more GDS systems.

Lastly, the information received from the travel database and the at least one GDS system is displayed to the user (block 1710). Generally the display will comprise one or more windows as described above, with information from both the travel database and the GDS systems displayed and available simultaneously as display space permits.

Conclusion

Systems and methods for providing a graphical user interface for accessing multiple travel suppliers are disclosed. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A method for providing travel services, the method comprising:
maintaining a traveler database having traveler information;
receiving a request for at least one travel service, the request identifying a traveler;
requesting information regarding the at least one travel service from a Global Distribution System (GDS);
retrieving traveler data from the traveler database; and
displaying the traveler data in conjunction with the information from the GDS.

2. The method of claim 1, further comprising:
deferring a task related to the travel request;
routing the task to a travel counselor for completion.

3. The method of claim 2, wherein routing the task includes determining the travel counselor to receive the task based on the type of task.

4. The method of claim 2, wherein routing the task includes determining that a travel related service has become available.

5. The method of claim 2, wherein routing the task includes determining a skill grouping for the task.

6. The method of claim 1, wherein the at least one travel service includes an airline reservation service.

7. The method of claim 1, wherein the at least one travel service includes a hotel reservation service.

8. The method of claim 1, wherein the at least one travel service includes a rental car reservation service.

9. The method of claim 1, wherein the at least one travel service includes a train reservation service.

10. The method of claim 1, wherein the at least one travel service includes a limousine reservation service.

11. The method of claim 1, wherein retrieving traveler data from the traveler database includes retrieving data regarding a previous itinerary and further comprising copying the data regarding the previous itinerary into a current itinerary.

12. The method of claim 1, wherein retrieving traveler data from the traveler database includes retrieving data regarding a co-traveler and further comprising copying the data regarding the co-traveler's itinerary into a current traveler's itinerary.

13. The method of claim 1, further comprising:
retrieving corporate travel data, said data including at least one travel policy;
determining a valid travel service option from the information from the GDS in accordance with the at least one travel policy.

14. A computerized traveler service system comprising:
a travel services component capable of being communicably coupled to at least one Global Distribution System (GDS);
a database management system operably coupled to the travel services component;
a client database maintained by the database management system and having client information; and
a traveler database maintained by the database management system and having traveler information;
wherein the travel services component presents graphical user interface (GUI) elements selected from the at least one GDS and the traveler database in response to a request.

15. The computerized system of claim 14, wherein the at least one GDS includes the Sabre system.

16. The computerized system of claim 14, wherein the at least one GDS includes the Galileo system.

17. The computerized system of claim 14, wherein the at least one GDS includes the Amadeus system.

18. The computerized system of claim 14, wherein the at least one GDS includes the Worldspan system.

19. The computerized system of claim 14, wherein the at least one GDS includes an airline reservation system.

20. The method of claim 14, wherein the at least one GDS includes a hotel reservation service.

21. The computerized system of claim 14, wherein the at least one GDS includes a rental car reservation system.

22. The computerized system of claim 14, wherein the at least one GDS includes a train reservation system.

23. The computerized system of claim 14, wherein the at least one GDS includes a limousine reservation system.

24. The computerized system of claim 14, further comprising a call management system operative to forward requests to a user of the travel services component.

25. A computer-readable medium having computer-executable instructions for performing a method for providing travel services, the method comprising:
maintaining a traveler database having traveler information;
receiving a request for at least one travel service, the request identifying a traveler;
requesting information regarding the at least one travel service from a Global Distribution System (GDS);
retrieving traveler data from the traveler database; and
displaying the traveler data in conjunction with the information from the GDS.

26. The computer-readable medium of claim 25, wherein the method further comprises:
deferring a task related to the travel request;
routing the task to a travel counselor for completion.

27. The computer-readable medium of claim 26, wherein routing the task includes determining the travel counselor to receive the task based on the type of task.

28. The computer-readable medium of claim 26, wherein routing the task includes determining that a travel related service has become available.

29. The computer-readable medium of claim 26, wherein routing the task includes determining a skill grouping for the task.

30. The computer-readable medium of claim 25, wherein the at least one travel service includes an airline reservation service.

31. The computer-readable medium of claim 25, wherein the at least one travel service includes a hotel reservation service.

32. The computer-readable medium of claim 25, wherein the at least one travel service includes a rental car reservation service.

33. The computer-readable medium of claim 25, wherein the at least one travel service includes a train reservation service.

34. The computer-readable medium of claim 25, wherein the at least one travel service includes a limousine reservation service.

35. The computer-readable medium of claim 25, wherein retrieving traveler data from the traveler database includes retrieving data regarding a previous itinerary and further comprising copying the data regarding the previous itinerary into a current itinerary.

36. The computer-readable medium of claim 25, wherein retrieving traveler data from the traveler database includes retrieving data regarding a co-traveler and further comprising copying the data regarding the co-traveler's itinerary into a current traveler's itinerary.

37. The computer-readable medium of claim 25, wherein the method further comprises:
retrieving corporate travel data, said data including at least one travel policy;
determining a valid travel service option from the information from the GDS in accordance with the at least one travel policy.
